(19) United States
(12) Patent Application Publication
(10) Pub. No.: US 2013/0073069 A1
(43) Pub. Date: Mar. 21, 2013

(54) SCHEDULING METHOD AND RECORDING MEDIUM HAVING SCHEDULING PROGRAM RECORDED THEREON FOR SUBSTRATE TREATING APPARATUS

(71) Applicants: Masahiro YAMAMOTO, Kyoto (JP); Hiroyuki ARAKI, Kyoto (JP)

(72) Inventors: Masahiro YAMAMOTO, Kyoto (JP); Hiroyuki ARAKI, Kyoto (JP)

(21) Appl. No.: 13/608,414

(22) Filed: Sep. 10, 2012

(30) Foreign Application Priority Data
Sep. 16, 2011 (JP) 2011-203459
Mar. 5, 2012 (JP) 2012-048393

(51) Int. Cl. G06F 19/00

(52) U.S. Cl. 700/100

(57) ABSTRACT

A scheduling method suitable for a single-substrate type substrate treating apparatus is provided. In the scheduling method, a controller provided in the substrate treating apparatus prepares schedule defining performances of the substrate treating apparatus having a single-substrate type treating unit in a time sequential order. The method comprises the steps of: a step for preparing a plurality of tentative timetables for a plurality of respective substrates, each of the tentative timetables combining a plurality of blocks in a time sequential order, each of the blocks defining a treatment content for one of the substrates; and a scheduling step for preparing a total schedule by acquiring the blocks from the plurality of tentative timetables to dispose the acquired blocks in a time sequential order.

### BACKGROUND OF THE INVENTION

1. Field of the Invention

The present invention relates to a scheduling method and a computer-readable recording medium having a computer program recorded thereon for a substrate treating apparatus for preparing schedule defining performances thereof in a time sequential order. Examples of substrates to be processed include semiconductor substrates, glass substrates for liquid crystal displays, glass substrates for plasma displays, substrates for FEDs (field emission displays), substrates for optical discs, substrates for magnet-optical discs, glass substrates for photomasks, substrates for ceramics, substrates for solar cells, etc.

2. Description of Related Art

JP-A-2008-218449 and US2008/0202260A1 disclose a scheduling method for determining timing to use resources provided in a substrate treating apparatus. Specifically, technique for preparing schedule defining timing to use resources for transfer mechanism, chemical liquid treatment member, deionized water treatment member, dry treatment member, etc. in a batch-type substrate treatment apparatus for collectively processing a plurality of substrates which constitute a substrate lot are disclosed. A controller provided in the substrate treatment apparatus activates each of the resources according to a prepared schedule. Thereby respective treatments for individual substrate lots are processed efficiently, increasing productivity of the substrate treatment apparatus.

### SUMMARY OF THE INVENTION

Single-substrate type substrate treatment apparatus, which treats one single substrate at a time, has come to be used for treating substrate (for example, substrate cleaning) with enhanced precision. But whereas either of the above-mentioned relative arts is adequate for batch-type substrate treatment apparatus, neither of the relative arts can necessarily yield a efficient substrate treatment by applying them as things are for single-type substrate treatment apparatus.

Therefore, it is an object of the present invention to provide a scheduling method and recording medium having scheduling program recorded thereon suitable for single-substrate type substrate treating apparatus.

The present invention provides a scheduling method for a substrate treating apparatus having a single-substrate type treating unit for treating one single substrate at a time and a controller provided in the substrate treating apparatus for preparing schedule defining performances of the substrate treating apparatus in a time sequential order, comprising the steps of: a step for preparing a plurality of tentative timetables for a plurality of respective substrates, each of the tentative timetables combining a plurality of blocks in a time sequential order, each of the blocks defining a treatment content for one of the substrates; and a scheduling step for preparing a total schedule by acquiring the blocks from the plurality of tentative timetables to dispose the acquired blocks in a time sequential order.

According to this method, a controller of a substrate treatment apparatus prepares a plurality of tentative timetables for respective substrates. Each of the tentative timetables is prepared by combining a plurality of blocks in a time sequential order, each of the blocks defining treatment content for one of the substrates. For example, the controller prepares a tentative timetable by combining a plurality of blocks in a time sequential order according to a treatment condition for a substrate and a recipe defining treatment condition. Each of the tentative timetables is prepared without considering interferences (overlaps of resources to be utilized in a time axis) between the plurality of substrates. Upon completion of the tentative timetables, the controller prepares a total schedule for efficiently treating a plurality of substrates. In doing so, the controller disposes blocks constituting the tentative timetables for respective substrates in a time sequential order, so as to avoid generating interferences among a plurality of substrates. Accordingly, it is possible to increase operation rate for resources of a single-substrate type treating unit or the like by disposing treatment blocks for each substrates, improving productivity thereof.

The scheduling step preferably includes maintenance block disposing step for disposing a maintenance block for a maintenance procedure that is to be executed either before or after a treatment of a substrate.

Examples of the maintenance procedure are a preparation procedure in the treatment unit, a postprocess procedure in the treatment unit, or the like.

As an example of preparation procedure, pre-dispensing procedure, in which a given amount of treatment liquid is dispensed from a treatment liquid nozzle, can be cited. For Example, in a case that a temperature-adjusted treatment liquid is supplied onto a substrate to treat the substrate, it is possible to channel a temperature-adjusted treatment liquid at a dispense spout of a treatment liquid nozzle by executing a pre-dispensing procedure to discharge a treatment liquid, of which temperature coming to range outside of a target temperature because of stagnation of the treatment liquid in the treatment liquid nozzle or a treatment liquid pipe. And then by executing a treatment liquid supply procedure for dispensing a treatment liquid to the substrate after the pre-dispensing procedure, it is possible to treat a substrate with a treatment liquid that is temperature-adjusted from the start. Thereby substrate treatment with precision can be realized. As another example of preparation procedure, cleaning treatment of a treatment chamber (chamber) provided in a treatment unit (chamber cleaning) can be cited. By executing a cleaning in the treatment chamber, substrate transferred into the treatment chamber thereafter can avoid being adversely affected by treatments exerted on formerly treated substrates. Thereby it is possible to realize substrate treatments with precision. The chamber cleaning includes, for example, a cleaning of a spin chuck that holds and rotates a substrate, a cleaning of a treatment cup for accommodating the spin-chuck, a cleaning of a guard (splash-proof member) for receiving treatment liquid splashed from the spin-chuck, or the like. Cleaning of a chuck-pin for holding a substrate, cleaning of other parts in the treatment chamber, or the like can also be cited as examples for the preparation procedure.

As a postprocess procedure, a cleaning treatment of the interior of the treatment chamber provided in the treatment unit (chamber cleaning) can be cited as an example. By executing a cleaning for the interior of the treatment chamber, a substrate transferred into the treatment chamber thereafter can avoid being adversely affected by treatments exerted on formerly treated substrates. Thereby it is possible to realize substrate treatments with precision. Specifics for the chamber cleaning are same as described herein above. Cleaning of a chuck-pin for holding a substrate, cleaning of other parts in a treatment chamber, or the like can also be cited as examples for the postprocess procedure.

In a preferred embodiment of the present invention, each of the tentative timetables includes a treatment block representing a treatment to be executed for a substrate in the treating unit, and the maintenance block disposing step includes: a step for determining whether the treatment block satisfies a given maintenance-execution condition or not; and a step for disposing the maintenance block before the treatment block in a time axis when the treatment block satisfies the maintenance-execution condition.

According to this method, it is determined whether the treatment block satisfies a given maintenance-execution condition or not, then based on the judgment, it is determined whether the maintenance block should be disposed or not. Namely, a maintenance block is disposed as required, skipping unnecessary maintenance procedure. Thereby it is possible to improve productivity of substrate treatment apparatus.

The maintenance block may be a block representing a preparation procedure to be executed before a treatment in the treatment unit. Also, the maintenance block may be a block representing a postprocess procedure to be executed after another treatment that is executed in the treatment unit prior to the later treatment in the treatment unit.

In a preferred embodiment of the present invention, each of the tentative timetables includes a treatment block representing a treatment to be executed for a substrate in the treating unit, and the maintenance block disposing step includes: a step for determining whether a first treatment that is scheduled for a first substrate and is to be executed by the treatment unit, and a second treatment that is scheduled for a second substrate and is to be executed next by the treatment unit satisfy a given maintenance-execution condition; and a step for disposing the maintenance block between a first treatment block for the first treatment and a second treatment block for the second treatment.

According to this method, it is determined whether a first treatment that is scheduled for a first substrate and a second treatment that is scheduled for a second substrate, wherein both treatments are to be executed in tandem by the same treatment unit, satisfy a given maintenance-execution condition. Based on the determination, it is decided whether the maintenance block should be disposed or not. Accordingly, unnecessary maintenance procedure can be skipped, improving productivity of substrate treatment apparatus.

The maintenance-execution condition includes, for example, a condition that a chemical liquid used for a first substrate and a chemical liquid used for a second substrate are different. Thereby it is possible to prevent adverse effects of chemical liquid used for the first substrate from affecting treatment of the second substrate. Also, when treatment is performed by the same type of chemical liquid to the first and second substrates, because the maintenance execution condition is not satisfied, maintenance block is not disposed. In this case, it is possible to avoid adverse effect to the second substrate, and to increase productivity by skipping maintenance procedure.

The maintenance block may be a block representing a postprocess procedure for a first treatment, or a block representing a preparation procedure for a second treatment.

In a preferred embodiment of the present invention, the maintenance-execution condition includes any of a condition for elapsed time from a end of the first treatment block to a start of the second treatment block, a condition for treatment content for the first and second treatment, and a condition for a number of treated substrates in the treatment unit.

For example, a condition that elapsed time from a end of the first treatment block to a start of the second treatment block exceeds a given time may be adopted as one of the maintenance-execution condition. Thereby it is possible to improve treatment quality for a second substrate. For example, in a case that the elapsed time surpasses a given time, a maintenance block representing a pre-dispensing procedure from a treatment liquid nozzle as a preparation procedure prior to a treatment for a second substrate. This permits supply of well-conditioned (for example, temperature controlled) treatment liquid onto the second substrate right from the start, thus improving substrate treatment quality.

Also, a condition that a first treatment and a second treatment are different may be adopted as one of the maintenance-execution condition. Thereby it is possible to improve treatment quality for a second substrate. For example, in a case that a first treatment and a second treatment use different chemical liquids, a maintenance block representing a cleaning of interior of a treatment chamber of the treatment unit as a postprocess procedure after a first treatment. This permits a second substrate to avoid being adversely affected by a chemical liquid that treated a first substrate. Also, as a preparation procedure prior to a second treatment, a maintenance block representing a pre-dispensing procedure from a treatment liquid nozzle for dispensing a chemical liquid that is to be used in the second treatment. This permits supply of well-conditioned (for example, temperature controlled) treatment liquid onto the second substrate right from the start, thus improving substrate treatment quality.

Also, a condition that a number of already treated substrates have reached at a given number may be adopted as a maintenance-execution condition. Thereby each time a given number of substrates are treated, a maintenance procedure is executed, improving substrate treatment quality. Maintenance procedure in this case may be, specifically, a cleaning procedure of the interior of a treatment chamber of the treatment unit. Thereby contaminants accumulated in the treatment chamber as a result of treatments of many number of substrate can be eliminated on a routine basis, allowing the continuation of high-quality substrate treatments.

In a preferred embodiment of the present invention, each of the tentative timetables includes a treatment block representing a treatment to be executed for a substrate in the treatment unit, and the maintenance block disposing step includes: a step for determining whether a first treatment by the treatment unit which is scheduled for a first substrate, and a second treatment by the treatment unit which is scheduled for a second substrate that is to be executed next by the treatment unit after the first substrate are same or not and a step for disposing the maintenance block between a first treatment block for the first treatment and a second treatment block for the second treatment when the first treatment and the second treatment are different, and skipping disposition of the maintenance block when the first treatment and the second treatment are the same.

According this method, disposition maintenance block is skipped when respective treatments for a first and second substrate, treatment of which is executed in the same treatment unit one after the another, are the same. Thus it is possible to skip an unnecessary maintenance procedure, improving productivity of a substrate treatment apparatus.

In a preferred embodiment of the present invention, each of the tentative timetables includes a treatment block representing a treatment to be executed for a substrate in the treating unit, and the maintenance block disposing step includes: a step for determining whether a postprocess procedure that is to be executed by the treatment unit after a treatment for a first substrate, and a preparation process that is to be executed in the treatment unit before a treatment for a second substrate, wherein the second substrate is to be treated by the treatment unit after the first substrate, are the same or not and a step for disposing a postprocess block for the postprocess procedure and a preparation block for the preparation procedure between a first treatment block for the first substrate and second treatment block for the second substrate as the maintenance block when the postprocess procedure and the preparation process procedure are different, and skipping disposition of the maintenance block when the postprocess procedure and the preparation procedure are the same.

According this method, disposition maintenance block is skipped when a postprocess procedure that is to be executed by the treatment unit after a treatment for a first substrate, and a preparation process that is to be executed in the treatment unit before a treatment for a second substrate are the same. The same procedure for postprocess and preparation translates to the same treatments for a first and second substrates, thereby obviating the need for exerting a maintenance procedure between the treatments for the first and second substrates. By skipping a maintenance procedure in such case, it is possible to improve productivity for substrate treatment apparatus.

In a preferred embodiment of the present invention, the maintenance block disposing step includes: a step for determining whether a part of a treatment content of either one of the postprocess procedure and preparation procedure, and an entirety of a treatment content of another one of the postprocess procedure and preparation procedure are the same or not; and a step for disposing a maintenance block corresponding to the either one of the postprocess procedure and preparation procedure between a first treatment block for the first substrate and second treatment block for the second substrate, and skipping disposition of a maintenance block corresponding to the another one of the postprocess procedure and preparation procedure, when a part of a treatment content of the either one and an entirety of a treatment content of the another one are the same.

In this method, when treatment content for the postprocess procedure and preparation procedure overlap each other and either one of the procedures includes other one of the procedure, a maintenance block corresponding to the either one of the postprocess and preparation procedures is disposed. This allows skipping of overlapping treatments, thus improving productivity of substrate treatment apparatus while executing required maintenance treatments.

The present invention also provides a computer-readable recording medium having a computer program recorded thereon for a substrate treating apparatus having a single-substrate type treating unit for treating one single substrate at a time, preparing a schedule defining performances of the substrate treating apparatus in a time sequential order, in which the computer program a set of instruction steps is encoded so that aforementioned scheduling method according is executable on a computer as the controller.

According to the present invention, the aforementioned described effects can be achieved regarding scheduling method.

The aforementioned and other objects, features, and effects of the present invention shall be clarified by the following description of the following preferred embodiments with references to the accompanying drawings.

### BRIEF DESCRIPTION OF THE DRAWINGS

FIG. 1 is a schematic plan view showing a layout of a substrate treatment apparatus according to a preferred embodiment of the present invention.

FIG. 2 is a schematic side view of the substrate treatment apparatus.

FIG. 3 is a block diagram for illustrating electrical components of the substrate treatment apparatus.

FIG. 4 is a flowchart for illustrating a first preferred embodiment of the present invention, in which an example of treatment by scheduling-function member.

FIG. 5 is a flowchart for illustrating the first preferred embodiment, in which an example of treatment by scheduling-function member.

FIG. 6 shows an example of a tentative timetable.

FIG. 7 shows an example of scheduling (disposition of preparation block).

FIG. 8 shows an example of scheduling (disposition of blocks for substrate treatment).

FIG. 9 shows an example of scheduling (disposition of blocks for substrate treatment).

FIG. 10 shows an example of scheduling (disposition of postprocess blocks).

FIG. 11 shows an example of scheduling (disposition of blocks for substrate treatment).

FIG. 12 shows an example of scheduling (disposition of blocks for substrate treatment).

FIG. 13 is a flowchart for illustrating a second preferred embodiment of the present invention, in which an example of treatment executed by a scheduling-function member.

FIG. 14 shows an example of scheduling (disposition of blocks for substrate treatment in case that neither of preparation-execution condition nor postprocess-execution condition is satisfied).

FIG. 15 shows an example of scheduling (disposition of blocks for substrate treatment in case that postprocess block is inserted).

FIG. 16 shows an example of scheduling (disposition of blocks for substrate treatment).

FIG. 17 shows an example of scheduling (disposition of blocks for substrate treatment, in case that preparation block is inserted).

FIG. 18 shows an example of scheduling (disposition of blocks for substrate treatment).

FIG. 19 shows an example of scheduling (disposition of blocks for substrate treatment).

FIG. 20 shows an example of scheduling (disposition of blocks for substrate treatment, in a case postprocess block is disposed).

FIG. 21 shows an example of scheduling (disposition of blocks for substrate treatment, in a case postprocess block and preparation block are disposed).

FIG. 22 is a flowchart showing a specific example of determination of preparation-execution condition.

FIG. 23 is a flowchart for illustrating a third preferred embodiment of the present invention, in which an example of treatment executed by a scheduling-function member.

FIG. 24 illustrates another example of decision made at STEP S46 or S48 in FIG. 22, or STEP S54 in FIG. 23.

### DETAILED DESCRIPTION OF THE PREFERRED EMBODIMENTS

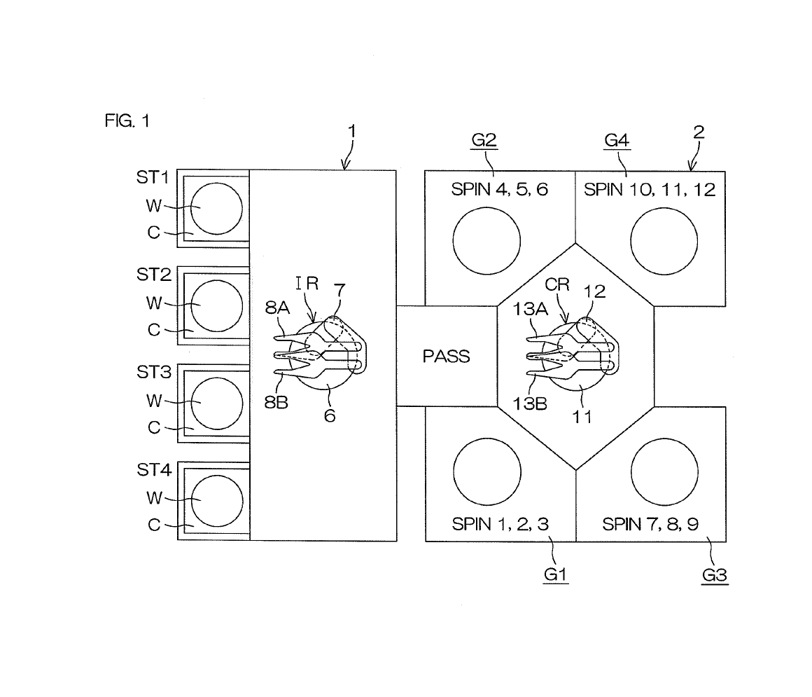

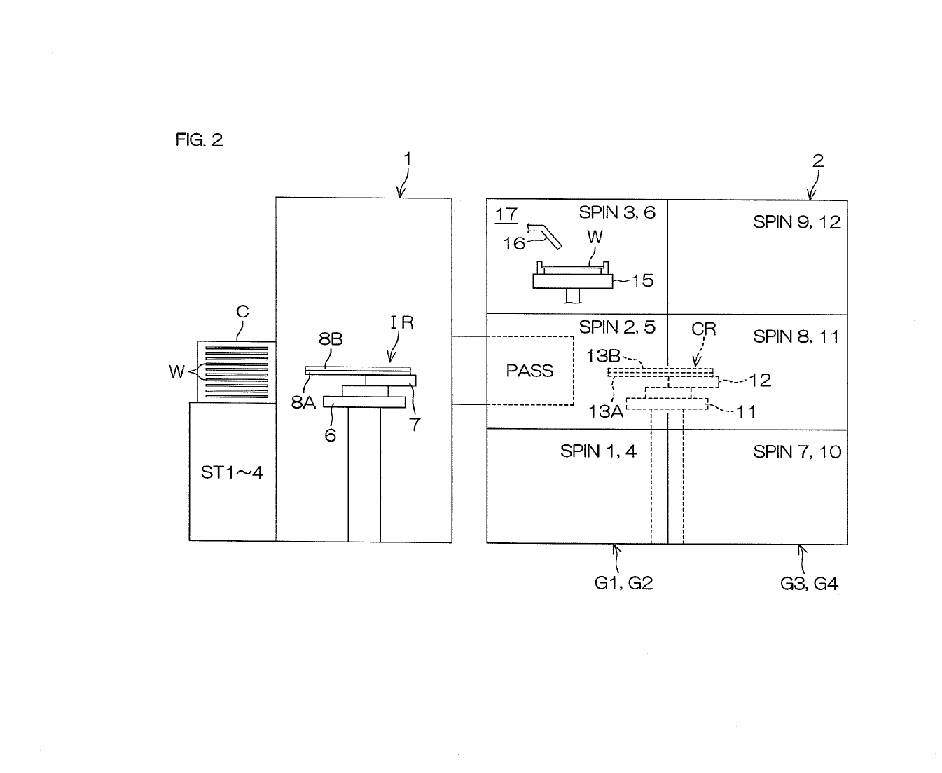

FIG. 1 is a schematic plan view showing a layout of a substrate treatment apparatus according to a preferred embodiment of the present invention; and FIG. 2 is a schematic side view of the substrate treatment apparatus. This substrate treatment apparatus includes an indexer section 1 and a treatment section 2. The treatment section 2 is provided with a transfer unit PASS, which transfers substrate to and from the indexer section 1. The indexer section 1 transfers an untreated substrate W to the transfer section 1, and receives a treated substrate W from the transfer unit PASS. The treatment section 2 receives the untreated substrate W from the transfer unit PASS. The treatment section 2 performs various treatments such as a treatment using treatment agent (treatment liquid or treatment gas), a treatment using electromagnetic waves such as ultraviolet rays, or a physical cleaning treatment (a brush cleaning, a spray nozzle cleaning or the like), on the substrate W. And then the treatment section 2 transfers the treated substrate W to the transfer unit PASS.

The indexer section 1 comprises a plurality of stages ST 1 to ST 4, and an indexer robot IR.

Each of the stages ST 1 to ST 4 is of substrate container that can hold a substrate which a plurality of substrates W (for example, wafer) are accommodated in a stack. The substrate may be a FOUP (Front Opening Unified Pod) which hermetically accommodates substrates W in a enclosed condition, SMIF (Standard Mechanical Interface) pod, or OC (Open Cassette) or the like. For example, when substrate containers C are mounted on the stages ST 1 to ST 4, a plurality of substrates W are vertically stacked in a horizontal posture with gaps from each other.

The indexer robot IR comprises, for example, a base member 6, an articulated arm 7, and a pair of hands 8A and 8B. The arm 6 is, for example, fixed on a frame of the substrate treatment apparatus. The articulated arm 7 is configured by combining a plurality of rotationally and horizontally moveable arm members such that: any one of the arms can rotationally moveable; and bending and stretching of the arms are brought by changing angles between arm members at joint members that are the points arm members are combined. The articulated arm is combined such that a distal member thereof is rotationally moveable relative to the base 6 around the vertical axis. Further, the articulated arm 7 is combined to be upwardly/downwardly moveable toward the base 6. Stated another way, the base 6 embeds a up/down drive mechanism for moving the articulated arm 7 upwardly/downwardly, and a rotation drive mechanism for rotating the articulated arm 7 around the vertical axis. Also, the articulated arm 7 is provided with an individual-rotation drive mechanism. Hand 8A and 8B are combined to the distal member of the articulated arm 7 to enable individually rotational movement around the vertical axis and individually horizontal forward/backward movement. Articulated arm 7 is provided with a hand rotation drive mechanism for individually rotating the hand 8A and 8B, and a hand forward/backward moving mechanism for forwardly/backwardly and horizontally moving the hand 8A and 8B. Each of the hand 8A and 8B is configured, for example, to be able to hold a substrate W. Incidentally, whereas hand 8A and 8B may be disposed in a overlappingly stacked condition, the hand 8A and 8B rendered in FIG. 1 are shown such that they are mutually staggered horizontally to the plane of paper for clarity.

With this configuration, the indexer robot IR is performed to transfer an untreated substrate W from the substrate container C held by one of the stages ST 1 to ST 4, then transfer the untreated substrate W to the transfer unit PASS. Further, the indexer robot IR is performed to receive a treated substrate W from the transfer unit PASS with the hand 8B, then accommodate the treated substrate W into a substrate container held by one of the stages ST 1 to ST 4.

The treatment section 2 comprises a plurality of (in the case of present embodiment, twelve) treatment unit SPIN 1-12, a main carrier robot CR, and the above-mentioned transfer unit Pass.

The treatment unit SPIN 1-12 are three-dimensionally disposed in the present preferred embodiment. To be more specific, the plurality of treatment unit SPIN 1-12 are disposed such that they constitute a three-storied structure, each disposed with four treatment units. Namely, four treatment unit SPIN 1, SPIN 4, SPIN 7, and SPIN 10 are disposed at the first-story portion; four treatment unit SPIN 2, SPIN 5, SPIN 8, and SPIN 11 are disposed at the second-story portion; and four treatment unit SPIN 3, SPIN 6, SPIN 9 and SPIN 11 are disposed at the third-story portion. To be more specific, the carrier robot CR is disposed in the middle of the treatment section 2 in planar view; and the transfer unit PASS is disposed between the main carrier robot CR and the indexer robot IR. A first treatment unit group G1 which is stacked with three treatment units SPIN 1-3; and a second treatment unit group G2 which is stacked with another three treatment units SPIN 4-6 are disposed as to be faced with each other across the transfer unit PASS. Then a third treatment unit group G3 which is stacked with three treatment units SPIN 7-9 is disposed as to be adjacent with the first treatment unit group G1, as well as to be at the farther side thereof from the indexer robot IR. Likewise a fourth treatment unit group G4 which is stacked with three treatment units SPIN 10-12 is disposed as to be adjacent with the first treatment unit group G2, as well as to be at the farther side thereof from the indexer robot IR. The main carrier robot CR is enclosed by the first to fourth treatment unit groups G1-4.

The main carrier robot CR comprises, for example, base member 11, an articulated arm 12, and a pair of hands 13A and 13B. The base member 11 is fixed, for example, on a frame of the substrate treatment apparatus. The articulated arm 12 is configured by combining a plurality of rotationally and horizontally moveable arm members such that: any one of the arms can rotationally moveable; and bending and stretching of the arms are brought by changing angles between arm members at joint members that are the points arm members are combined. The articulated arm 12 is combined such that a distal member thereof is rotationally moveable relative to the base member 11 around the vertical axis. Further, the articulated arm 12 is combined to be upwardly/downwardly moveable toward the base member 11. Stated another way, the base member 11 embeds a up/down drive mechanism for moving the articulated arm 12 upwardly/downwardly, and a rotation drive mechanism for rotating the articulated arm 12 around the vertical axis. Also, the articulated arm 12 is provided with an individual-rotation drive mechanism. Hand 13A and 13B are combined to the distal member of the articulated arm 12 to enable individually rotational movement around the vertical axis and individually horizontal forward/backward movement. The articulated arm 12 is provided with a hand rotation drive mechanism for individually rotating the hand 13A and 13B, and a hand forward/backward moving mechanism for forwardly/backwardly and horizontally moving the hand 13A and 13B. Each of the hand 13A and 13B is configured, for example, to be able to hold a substrate W. Incidentally, whereas hand 13A and 13B may be disposed in a overlappingly stacked condition, the hand 13A and 13B rendered in FIG. 1 are shown such that they are mutually staggered horizontally to the plane of paper for clarity.

With this configuration, the main carrier robot CR is performed to receive an untreated substrate W from the transfer unit PASS, then transfer the untreated substrate W to one of the treatment unit SPIN 1 to SPIN 12. Further, the main carrier robot CR is performed to receive a treated substrate W, treated in the treatment unit SPIN 1 to SPIN 12, with the hand 8B, then transfers the treated substrate W to the transfer unit PASS.

The treatment units SPIN 1-12 are single-substrate type treatment units for treating one single substrate at a time. Each of the treatment units SPIN 1-12 may be, for example, rotating liquid treatment unit that comprises, in a treatment chamber 17 (chamber), a spin chuck 15 for holding a substrate in a horizontal posture to rotate thereof and a treatment liquid nozzle 16 for supplying treatment liquids (chemical liquid or rinse liquid) toward the spin chuck 15. FIG. 2 shows the interior configuration of the treatment unit SPIN 3, leaving out the same of the other units.

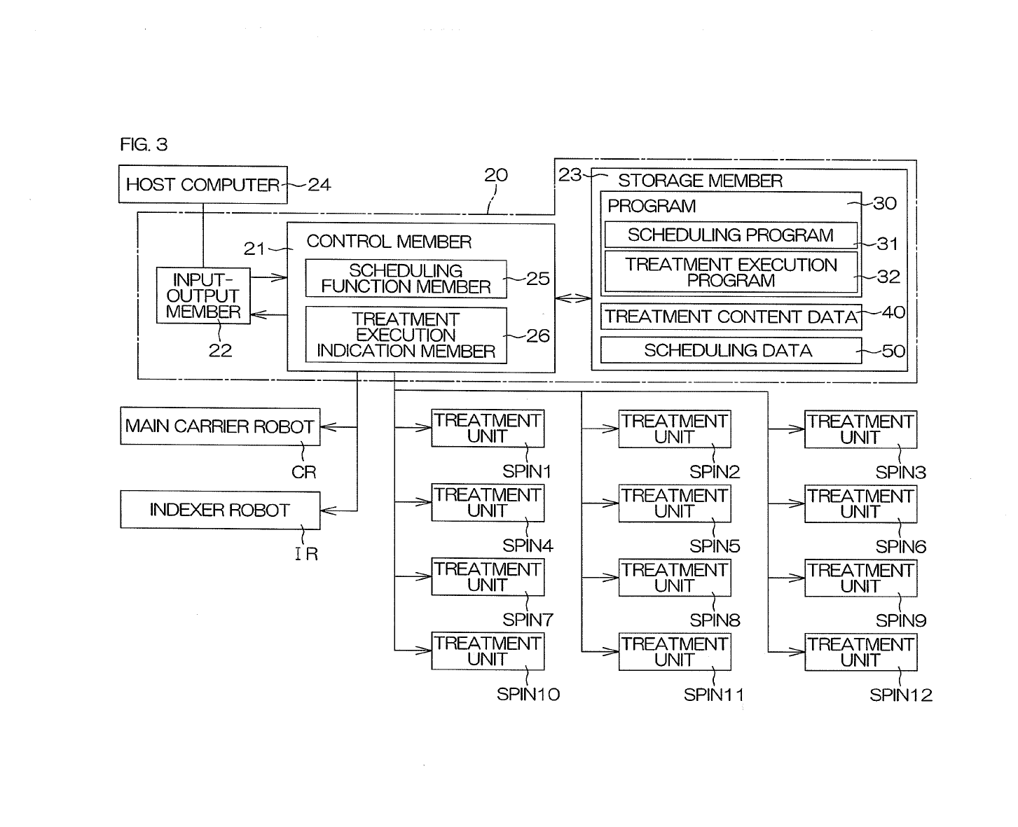

FIG. 3 is a block diagram for illustrating electrical components of the substrate treatment apparatus. The substrate treatment apparatus comprises the treatment unit SPIN 1-12, the main carrier robot CR, and a computer 20 for controlling the indexer robot. The computer 20 may be in a form of a personal computer (FA personal computer), comprises a control member 21, input-output member 22 and storage member 23. The control member 21 includes an calculation unit such as CPU and the like. The input-output member 22 comprises an output equipment such as a display unit and the like, a keyboard, a pointing device, and a touch panel display and the like. The input-output member 22 further includes a communication module to communicate with the host computer 24. The storage member 23 comprises a solid-state memory device, and hard-disk drive and the like.

The control member 21 comprises a scheduling function member 25 and a treatment execution indication member 26. The scheduling function member 25 prepares a schedule for activating resources of the substrate treatment apparatus in a time sequential order, so as to transfer a substrate W out of the substrate container C, treat the substrate W in the treatment unit SPIN 1 to SPIN 12, and then accommodate the substrate in the substrate container C. The treatment execution indication member 26 activates the resources of the substrate treatment apparatus according to the schedule prepared by the scheduling function member 25.

The storage member 23 is configured to store various data etc. comprising a program 30 for being executed by the control member 21, a treatment content data 40 received from a host computer 24, and a scheduling data 50.

The program 30 stored in the storage member 23 comprises a scheduling program 31 for activating the control member 21 as the scheduling function member 25, and a treatment execution program 32 for activating the control member 21 as a treatment execution indication member 26. The storage member 23 is an example of a computer-readable recording medium having a computer program recorded thereon.

Treatment content data 40 includes process job (PJ) codes each assigned to respective substrates W, and a recipe associated with the respective process job codes. A recipe is a data that defines treatment content for a substrate including a substrate treatment condition and a substrate treatment procedure. To be more specific, a recipe includes a parallel treatment unit information, usable treatment liquid information, treatment time information or the like. The parallel treatment unit information is an information that indicates an available treatment unit, representing a condition in that parallel treatment by the indicated treatment unit is possible. Stated otherwise, this represents a condition in that when one of the indicated treatment units is unavailable, it is possible to replace it with one of the other indicated treatment units. “UNAVAILABLE” specifically signifies a condition in which the treatment unit is in use for a treatment of other one of substrates W, the treatment unit is at fault, operator does not want to assign the treatment unit to a treatment of substrate W, or the like. A process job is assigned to one or more substrates W that are treated with common treatment. A process job code is a identification information to identify process job (substrate group identification information). Accordingly, each of the plurality of substrates W assigned with a common process job code is treated with a common treatment indicated by a recipe corresponding to the process job code. However, content of two recipes each corresponding to different process job code may happen to be the same. For example, when a plurality of substrates W, consecutive in treatment order (order to transfer substrate from substrate container C), is treated with a common treatment, a common process job code is assigned to the plurality of substrates W.

The control unit 21 acquires treatment content data for each of substrates W to store them in the storage member 23. Acquisition and storage of treatment content data is to be done before the execution of scheduling for each of substrates W. For example, treatment content data corresponding to the substrate W accommodated in a substrate container C may be given from the host computer 24 to the control 21 each time immediately after the substrate container C is held by stage ST 1-4.

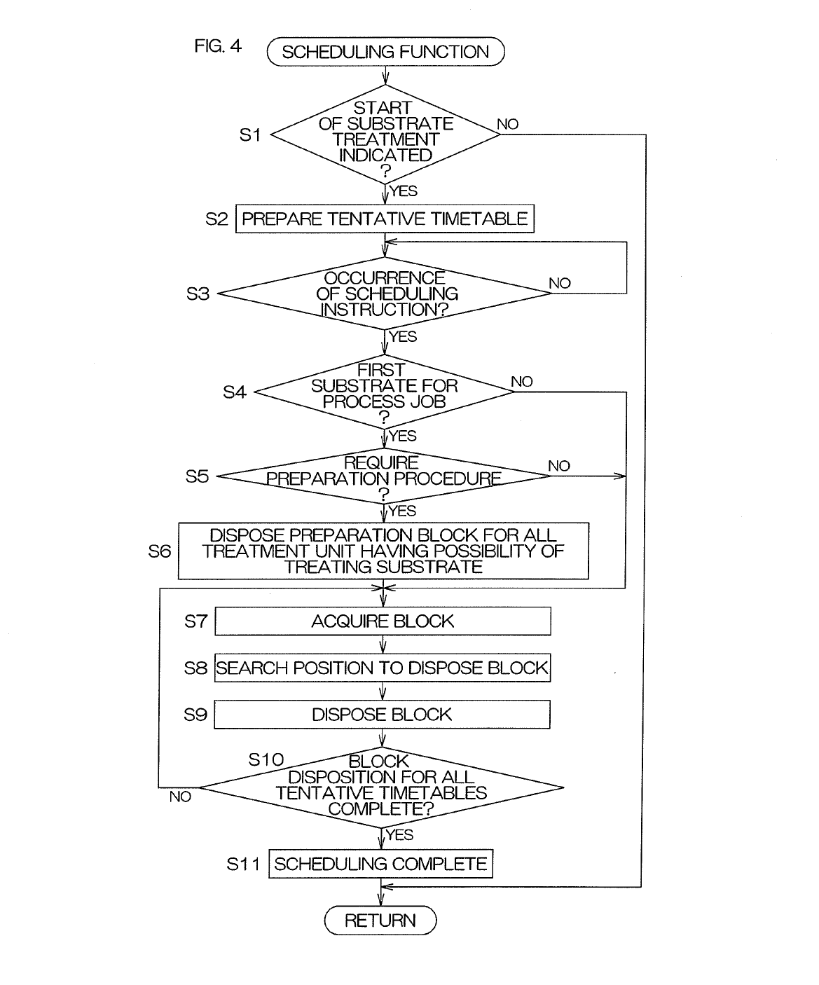

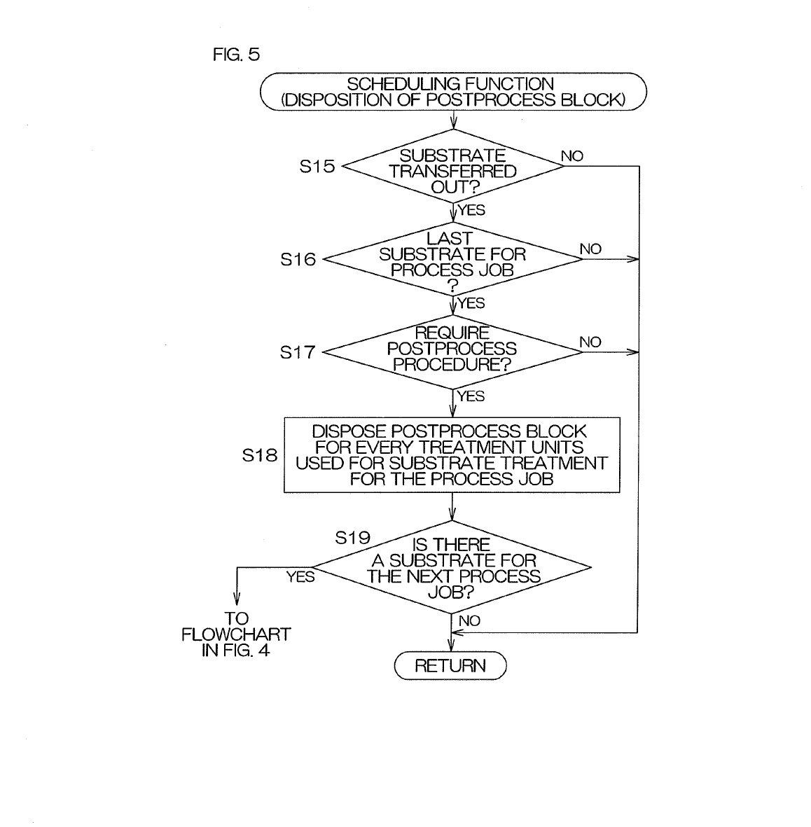

FIG. 4 and FIG. 5 are flowcharts for illustrating an example of treatment by scheduling-function member 25. To be more specific, they represent treatments processed by the control member 21 (computer 20) executing a scheduling program 31. Stated another way, the scheduling program 31 is embedded with group of steps so as to execute treatments shown in FIG. 4 and FIG. 5 on the computer.

When an instruction to start a substrate treatment from operator via a host computer 24 or an input-output member 22 is indicated (STEP S1), a scheduling function member 25 prepares a tentative timetable (STEP S2) for the every substrates W to which the instruction to start the substrate treatment is assigned. An instruction to start a substrate treatment may issued for every substrates W in a lump accommodated in the substrate container C. An instruction to start a substrate treatment may indicate start of treatment for one or a plurality of substrates assigned with process job codes.

Suppose that a recipe assigned to a process job code in the treatment content data indicates a parallel treatments of treatment units SPIN 1-12. Accordingly, a substrate treatment according to the recipe is supposed to be executable on any of the twelve treatment unit SPIN 1-12. In this case, there are twelve variations of path through which a substrate W assigned the process job code passes when treated. Namely, the selectable paths for the treatment of the substrate W are twelve paths that passes one of the treatment units SPIN 1-12. Thereby the scheduling function member 25 prepares tentative timetables corresponding to the twelve paths.

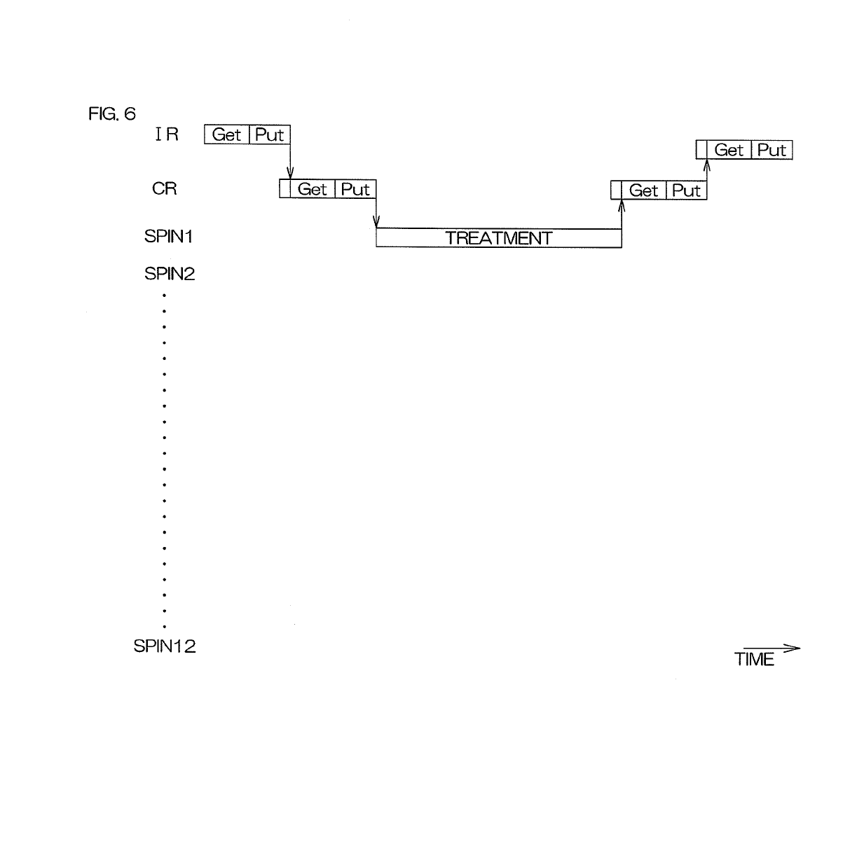

FIG. 6 shows a tentative timetable corresponding to path that passes a treatment unit SPIN 1. The tentative timetable comprises: a block representing that a substrate W is transferred from the substrate container C (“GET”) by the indexer robot IR; a block representing that the substrate W is transferred into a transfer unit PASS (“PUT”) by the indexer robot IR; a block representing that the substrate W is transferred from the transfer unit PASS (“GET”) by a main carrier robot CR; a block representing that the substrate W is transferred into a treatment unit SPIN 1 (“PUT”) by the main carrier robot CR; a block representing a treatment to the substrate W by the treatment unit SPIN 1; a block representing that the treated substrate W is transferred from the treatment unit SPIN 1 (“GET”) by the main carrier robot CR; a block representing that the substrate W is transferred to the transfer unit PASS (“PUT”) by the main carrier robot CR; block representing that the substrate W is transferred from the transfer unit PASS (“GET”) by the indexer robot IR; and a block representing that the substrate W is transferred into the substrate container C (“PUT”) by the indexer robot IR. The scheduling function member 25 prepares a tentative timetable by successively disposing these blocks such that these blocks do not overlap with each other on time axis. Tentative timetables (tentative timetables disposing treatment blocks to SPIN 2-12) for the same substrate W, corresponding to respective paths, each passing treatment unit SPIN 2-12, are prepared by the scheduling function member 25. In this manner, twelve tentative timetables in total per one single substrate are prepared.

For every substrates W assigned with the same process job code, respective tentative timetables are prepared likewise. The tentative timetables thus prepared are stored in the storage member 23 as a part of the scheduling data 50. In preparing tentative timetables, interferences of blocks for different substrates W (overlap on time axis) are not taken into account.

Upon occurrence of a scheduling instruction (STEP S3), disposition of blocks for the substrate W for the process job (total scheduling for STEP S4-11). To be more specific, the scheduling function member 25 reads out a tentative timetable for the substrate W from the storage member 23, then disposes blocks that constitute the tentative timetable, on time axis.

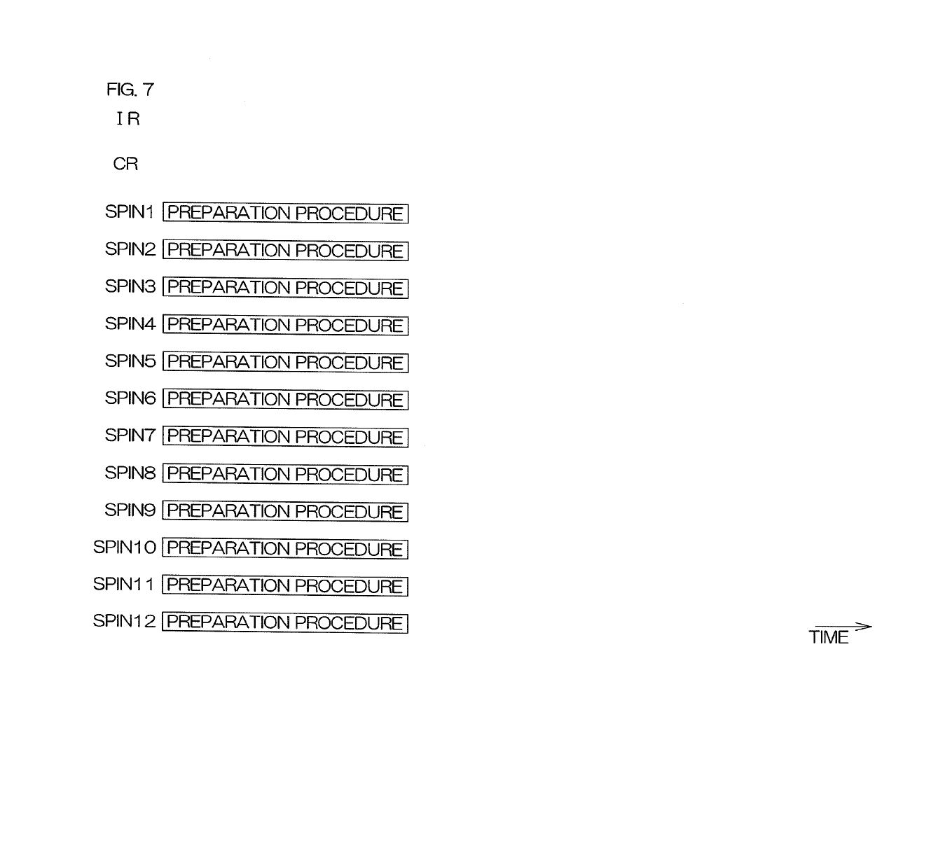

Stated more specifically, the scheduling function member 25 determines whether a substrate is the first substrate W for the process job (STEP S4). If the substrate is the first substrate W for the process job (STEP S4: “YES”) then the recipe corresponding to the process job is determined whether the recipe requires a preparation procedure (pre-dispensing etc) (STEP S5). The recipe assigned to process job code indicates whether at the preparation procedure is required or not. When the preparation procedure is required, a block representing execution of the preparation procedure (preparation block) is disposed (STEP S6) for the treatment units SPIN 1-12 having possibility of treating the substrate W (in the case of aforementioned example, that includes every treatment units). An example is shown in FIG. 7 in that preparation blocks are disposed for every treatment unit SPIN 1-12. When executing scheduling of a substrate other than the first substrate W for the process job (STEP S4: “NO”), treatments in STEP S5 and S6 are skipped. Treatment in STEP S6 is skipped also when executing scheduling of a first substrate W for the process job provided that the recipe corresponding to the process job do not indicate a preparation procedure (STEP S5 “NO”).

Next, the scheduling function member 25 references to a tentative timetable corresponding to the substrate W to acquire one of the blocks that constitute the tentative timetable (STEP S7). Position on the time axis of the then acquired block is at the most earliest side, compared to that of any of yet-to-be-disposed blocks. Further, scheduling function member 25 searches a position at which the acquired block can be disposed (STEP S8), and then disposes the block at the searched position (STEP S9). Each of the blocks is disposed at the most earliest then available position on the time axis while avoiding simultaneous overlapping of usages of a same resource. Similar procedures are repeated for all blocks constituting the tentative timetable (STEP S10). Upon completing disposition of the all blocks constituting the tentative timetable (STEP S10 “YES”), scheduling for the substrate W is completed (STEP S11). Similar procedures are repeated each in turn (for example, in a order that substrate is transferred out from the substrate container C) for all substrates W of the same process job.

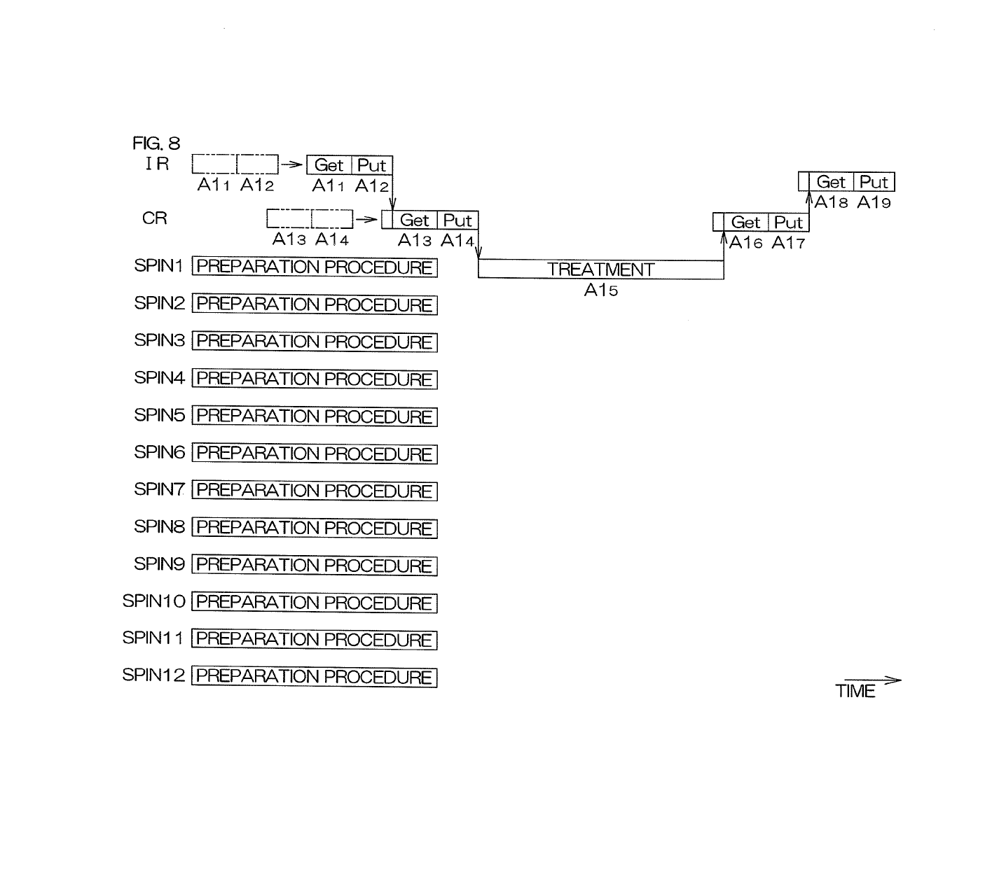

FIG. 8 is an example in which all the blocks A11 to A19 constituting a tentative timetable corresponding to a first substrate A1 for process job A are disposed. Treatment blocks are disposed after preparation blocks for a treatment unit SPIN 1. More specifically, the blocks constituting the tentative timetable for the substrate A1 are disposed such that preparation blocks and treatment blocks are not temporally overlap with each other. To be more specific, scheduling function member 25 disposes the blocks A11-19 acquired from the tentative timetable, wherein blocks are disposed at the then earliest available space on time axis (order of arrival and left justified) for respective resources. In doing this, scheduling function member 25 disposes the blocks so that they do not overlap with each other at a space for the same resource. Accordingly the treatment block A15 is to be disposed after the already-disposed preparation block. Therefore as in shown in alternate long and two short dashes lines, blocks A11-14 can be disposed without time gap, whereas by disposing the treatment A15 a time gap is introduced between the treatment blocks A14 and A15. Thus, upon anticipating that a time gap occurs by disposing the treatment block A15, the scheduling function member 25 delays starting time for the blocks A11-14 by shifting them backward on time axis so as not to introduce a time gap. Thereby a schedule is prepared in a condition illustrated in FIG. 8.

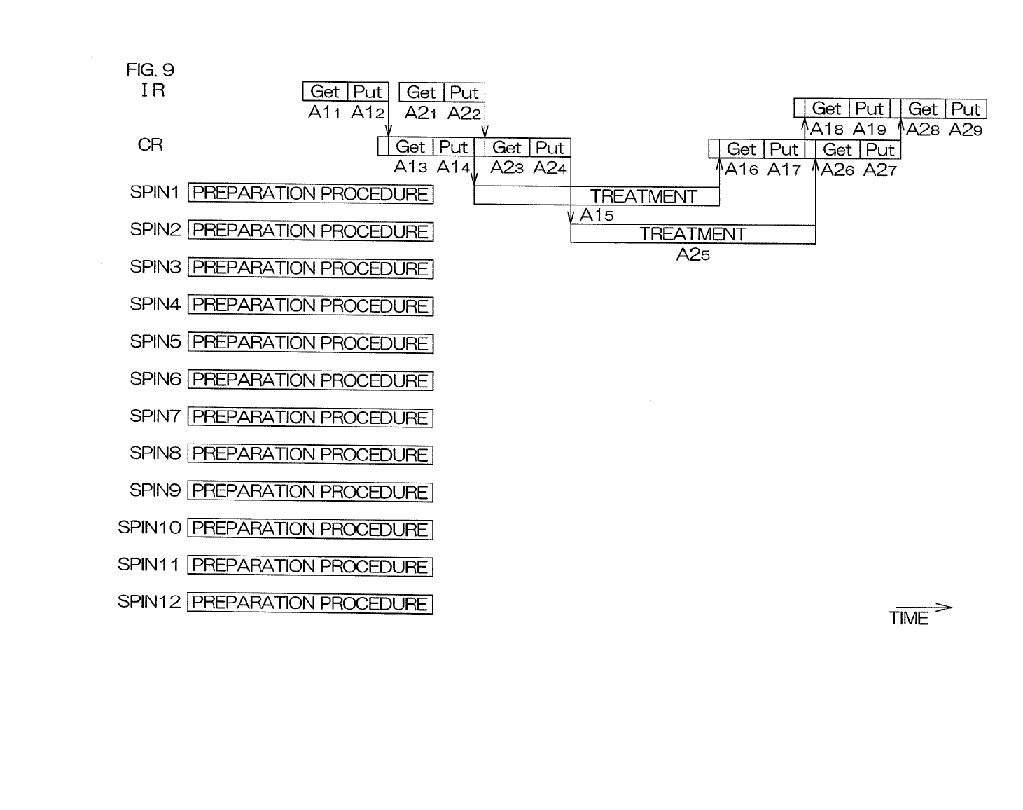

FIG. 9 is an example in which all the blocks A21-29 constituting a tentative timetable corresponding to a second substrate A2 for the same process job A are disposed. Blocks A21 and A22 for the indexer robot IR corresponding to second substrate A2, are disposed with minimum time gaps from respective A22 and A12 which correspond to first substrate A1 and are disposed at spaces for indexer robot IR. Likewise, blocks A23 and A24 for the main carrier robot CR which correspond to second substrate A2, are disposed with minimum time gaps from respective A13 and A14 which correspond to first substrate A1 and are disposed at spaces for main carrier robot CR. Since the treatment unit is unavailable (the treatment block A15 occupies the space) at a timing of completion for the block 24, The treatment block A25 for the second substrate A2 is disposed at a space in the treatment unit SPIN 2. Accordingly, the second substrate A2 is scheduled so as to be treated at the treatment unit SPIN 2. Incidentally, respective throughputs for the treatment unit SPIN 2-12 obtained by disposing the second substrate A2 are the same. In such a case, a treatment unit with a smaller chamber number is selected. Thereafter blocks A26 and A27 corresponding to the second substrate A2 for the main carrier robot CR, are disposed with minimum time gaps from the respective blocks A16 and A17 corresponding to the first substrate A1 for the main carrier robot CR, so as to be matched with the completion timing for the treatment block A25. Moreover, blocks A28 and A29 corresponding to the second substrate A2 for the indexer robot IR, are disposed with minimum time gaps from the respective blocks A18 and A19 corresponding to the first substrate A1 for the indexer robot IR, so as to be matched with the completion timing for the treatment block A27.

FIG. 5 shows procedures by scheduling function member 25 regarding disposition of preparation blocks. Postprocess blocks are blocks for indicating execution of postprocess procedures at treatment unit SPIN 1-12. A specific example of postprocess procedure is a cleaning treatment (chamber cleaning) of treatment chamber 17 of treatment unit SPIN 1-12. By executing the cleaning of the interior of the treatment chamber 17, it is possible to avoid transmitting of adverse effects of former substrates to the following substrates transferred into the treatment chamber 17. Thereby accurate substrate treatments realized.

When a substrate W is transferred out of the substrate container C held by the stages ST 1-4 (STEP S15), the scheduling function member 25 determines whether the substrate W is the last substrate W of a process job currently in process (STEP S16). If the substrate W is not the last one (STEP S16: “NO”), treatment is finished because attachment of a postprocess procedure block required. If the substrate W is the last one, scheduling function member 25 determines whether the recipe for the process job requires a postprocess (STEP S17). The recipe indicates whether a postprocess is required. If a postprocess is not required (STEP S17: “NO”), then the treatment is finished. If a postprocess is required (STEP S17: “YES”), then the scheduling function member 25 disposes postprocess blocks at spaces of all treatment units SPIN 1-12 scheduled to be used for treatments of a substrate W for the process job (STEP S18).

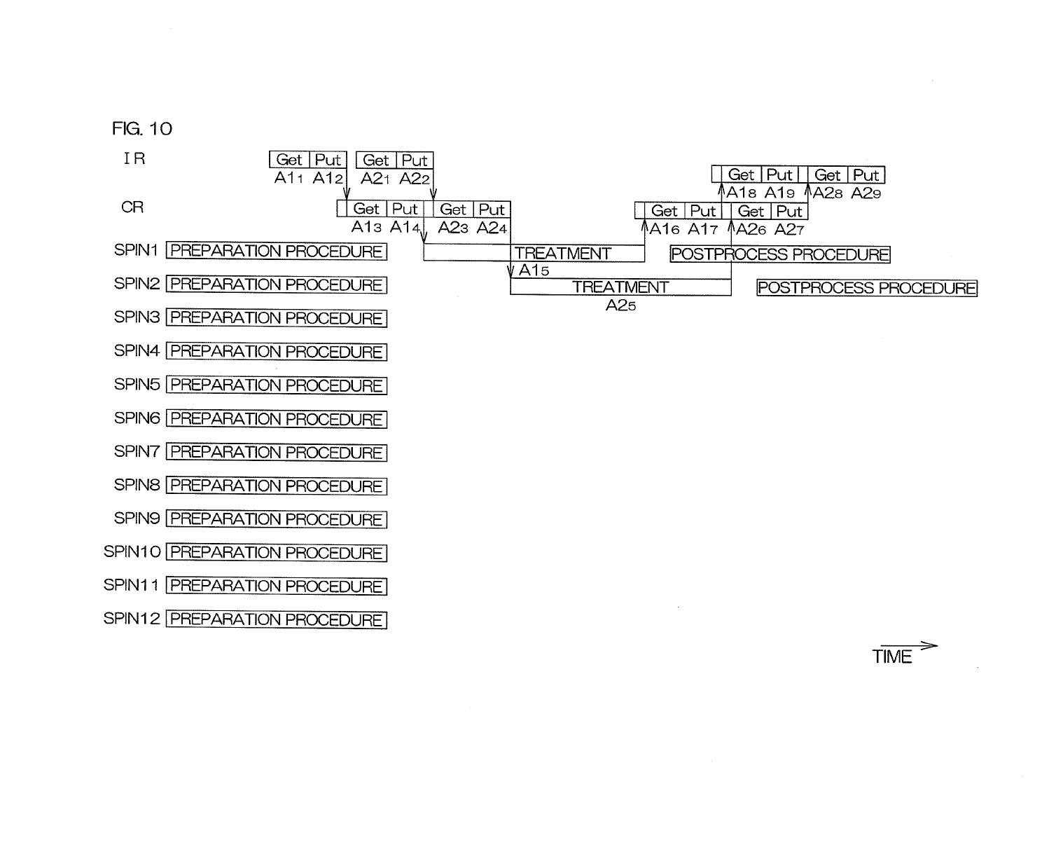

FIG. 10 is an example in which postprocess blocks are disposed. In this example, the treatment unit SPIN 1 and SPIN 2 execute treatments for respective substrates A1 and A2, each of them attached with the same process job code “A”. And posterior spaces for treatment blocks A15 and A25 are disposed with postprocess blocks.

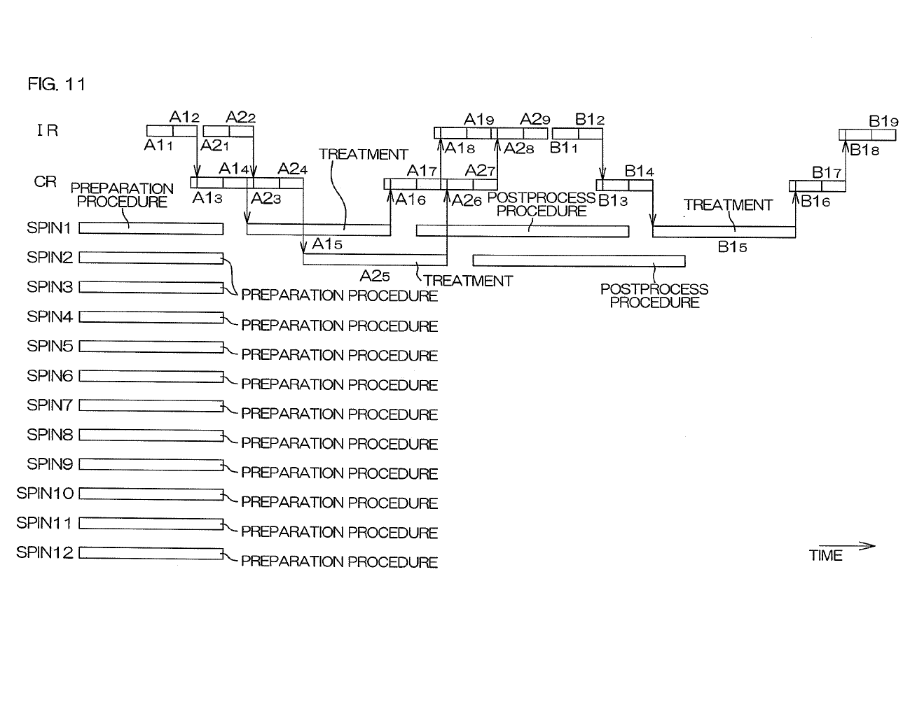

After disposition of a postprocess block (STEP S18) or when a postprocess is not required, the scheduling function member 25 determines whether the next process job has a substrate W or not. If a substrate W for the next process job exists (STEP S19: “YES”), treatment, shown in FIG. 4, is executed for the substrate W for the next process job. If a substrate for the next process job does not exist (STEP S19: “NO”), the treatment is finished. FIG. 11 shows an example in which blocks B11-19 corresponding to the first substrate B1 for the next process job B. In this example, the substrate B1 is scheduled to be treated in a treatment unit SPIN 1.

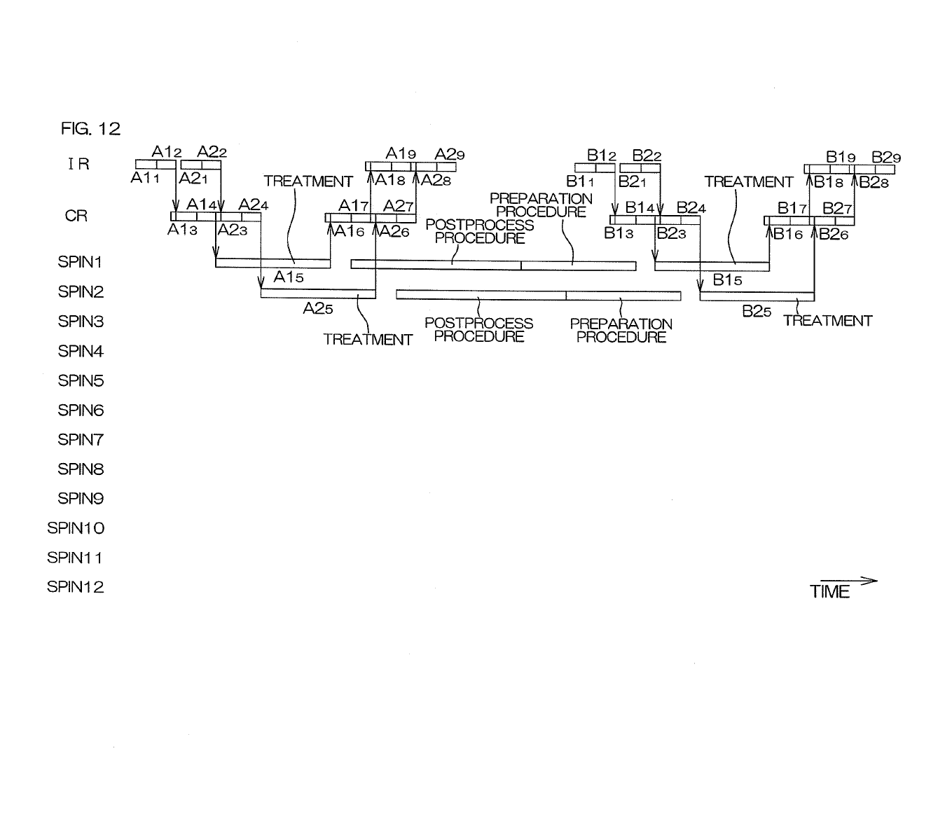

FIG. 12 shows a case in which a recipe for process job A is followed by postprocess indications, and a recipe for process job B is preceded by preparation indications. Also, recipe for process job B indicates parallel treatments in treatment units SPIN 1 and SPIN 2.

After treatment for the last substrate A2 for process job A starts, postprocess blocks are disposed for all the treatment units SPIN 1 and SPIN 2 that are used for treatments for the process job A. Further, postprocess blocks are disposed for all of the indicated treatment units SPIN 1 and SPIN 2 when treatment of the last substrate A2 for process job A starts. Thereafter blocks B11 to B19 for the first substrate B1 for process job B and blocks B21 to B29 for the second substrate B2 are disposed in turn.

As described hereinabove, with this preferred embodiment, tentative timetables for every possible paths are prepared for respective substrates W, each tentative timetable time-sequentially combining a plurality of blocks defining treatment content. Thereafter by acquiring blocks form the tentative timetables for the plurality of substrates and time-sequentially disposing the blocks so as not to interfere with each other (the same resource is not to be used simultaneously), a total schedule is prepared and stored in the storage member 23. Accordingly, a total schedule which can effectively operate single-substrate type treatment unit SPIN 1-12. The treatment execution indication member 26 activates resources of the substrate treatment apparatus according to a total schedule stored in the storage member 23. Thereby it is possible to increase operation ratio of various parts of single-substrate type substrate treatment apparatus, improving productivity.

Also, in this preferred embodiment, a maintenance block for a preparation procedure or a postprocess procedure can be disposed. Thereby it is possible to perform a required maintenance before or after treatments of a different process job, allowing a high-quality substrate treatment.

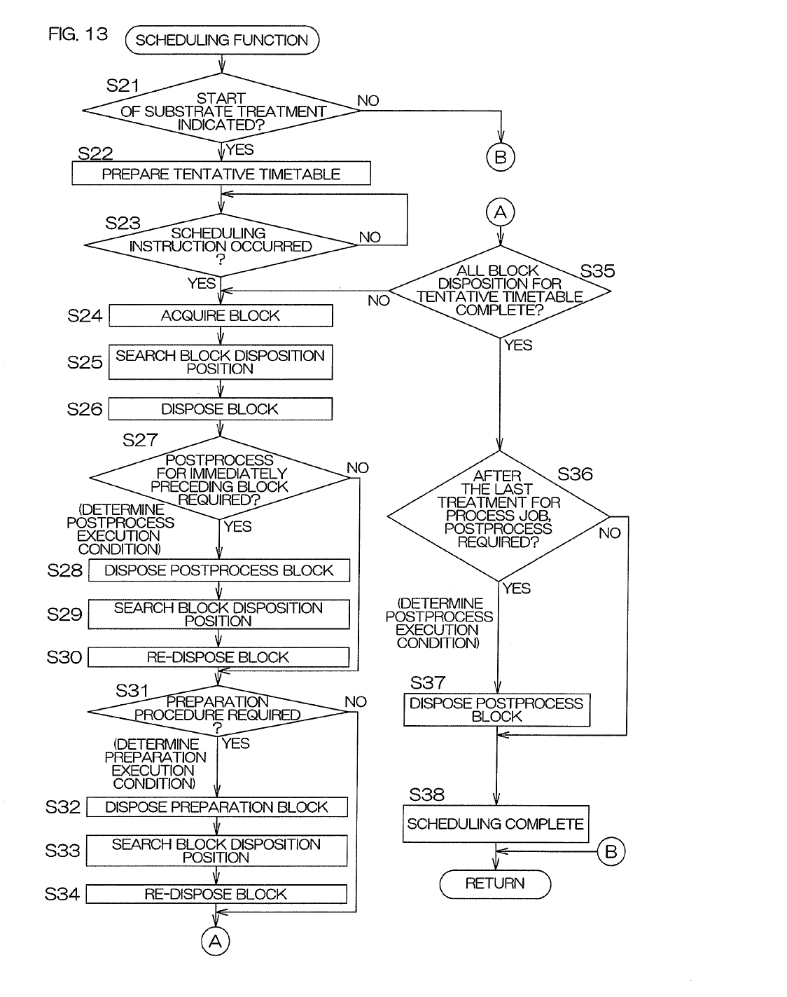

FIG. 13 is a flowchart for illustrating a second preferred embodiment of the present invention, in which an example of treatment executed by a scheduling-function member 25. In illustrating the second preferred embodiment, aforementioned FIG. 1-3 are to be referred again and differences with the first preferred embodiment will be mainly described. FIG. 13 shows treatments performed by executing a scheduling program 31 by a controller 21 (computer 20). In other words, in this preferred embodiment, scheduling program 31 are incorporated with a group of steps so that treatments shown in FIG. 13 are executed by computer.

When an instruction to start a treatment of a substrate from an operator via a host computer 24 or an output-input member 22 (STEP S21), the scheduling function member 25 prepares tentative timetables (STEP S22) for all the substrates W instructed to start substrate treatment. Instruction to start substrate treatment may be issued for a bundle of all the substrates W accommodated in the substrate container C. Instruction to start substrate treatment may be an instruction to start treatments of substrates for one or more process job. Preparation of a tentative timetable is performed in the similar manner as in the case of the aforementioned first preferred embodiment.

When an instruction to execute scheduling occurs (STEP S23), disposition of blocks regarding the substrate W of the process job is performed (STEP S24-38). To be specific, the scheduling function member 25 reads out a tentative timetable for the substrate W from the storage member 23, then disposes blocks that constitute the tentative timetable, on time axis.

To be stated more specifically, the scheduling function member 25 references to tentative timetable corresponding to the substrate W to acquire a block constituting the tentative timetable (STEP S24). The then acquired block is positioned at the most earliest side of the time axis, compared to any of the yet-to-be-disposed blocks. Further, scheduling function member 25 searches a position at which the acquired block can be disposed (STEP S25), and then disposes the block at the searched position (STEP S26). Each of the blocks is disposed at the most earliest then available position on the time axis while avoiding simultaneous overlapping of usages of a same resource.

The scheduling function member 25 determines whether block immediately preceding the disposed block requires postprocess procedure or not (STEP S27). In other words, the scheduling function member 25 determines whether given postprocess execution condition is satisfied or not. The postprocess execution condition herein comprises: a condition such that a disposed block is a treatment block representing a treatment in a treatment unit; and a condition such that a block immediately preceding the disposed block, wherein both blocks are for the same resource (treatment unit), is a treatment block corresponding to a substrate that is to be treated in the treatment unit last of all the substrates attached with a common process job code. Furthermore, a postprocess execution condition may include a condition concerning a recipe (treatment content) for a process job of the disposed treatment block and a recipe (treatment content) for a process job of a treatment block immediately preceding the disposed treatment block for the same resource. More specifically, it is preferable that a postprocess execution condition includes a condition such that a type of chemical liquid to be used indicated by a recipe corresponding to a process job for the disposed treatment block and a type of chemical liquid to be used indicated by a recipe corresponding to a process job immediately preceding the process job are different. That means, the above postprocess execution condition is not satisfied when the same type of chemical liquid is used for a treatment of consecutive process jobs. Furthermore, a postprocess execution condition may include a condition that a number of treated substrates reached a given number. By executing a postprocess (for example, a cleaning of the interior of a treatment chamber 17) every time a number of treated substrates reaches a given number, it is possible to maintain substrate-treatment quality.

After determining that a postprocess procedure is not required (STEP S27: “NO”), the scheduling function member 25 then determines whether a preparation procedure is required for the disposed block or not (STEP S31). In other words, the scheduling function member 25 determines whether a given preparation execution condition is satisfied or not. The preparation execution condition includes: a condition that a disposed block is a treatment block representing a treatment in a treatment unit; and a condition that the disposed block is a treatment block corresponding to a substrate which is to be treated in the treatment unit at first of all the substrates attached with a common process job code. Furthermore, the preparation execution condition may include a condition concerning a recipe (treatment content) corresponding to a process job for a disposed treatment block and a recipe (treatment content) corresponding to a process job for a treatment block immediately preceding the disposed treatment block for the same resource. More specifically, it is preferable that preparation execution condition may include a condition in that a type of chemical liquid to be used indicated in a recipe corresponding to a process job for a disposed treatment block is different from a type of chemical liquid to be used indicated in a recipe corresponding to a process job for a treatment block immediately preceding the disposed block for the same resource.

Accordingly, the preparation execution condition is not satisfied when the two chemical liquids used are of the same type. Furthermore, the preparation execution condition may include a condition in that time lapse after the last usage of the treatment unit exceeds a given time (for example, five minute).

When the preparation execution condition is not satisfied (STEP S31: “NO”), scheduling function member 25 determines whether disposition of all the blocks constituting a tentative timetable is completed (STEP S35), to repeat treatments STEP S24 and thereafter as long as there remains a yet-to-be-disposed block.

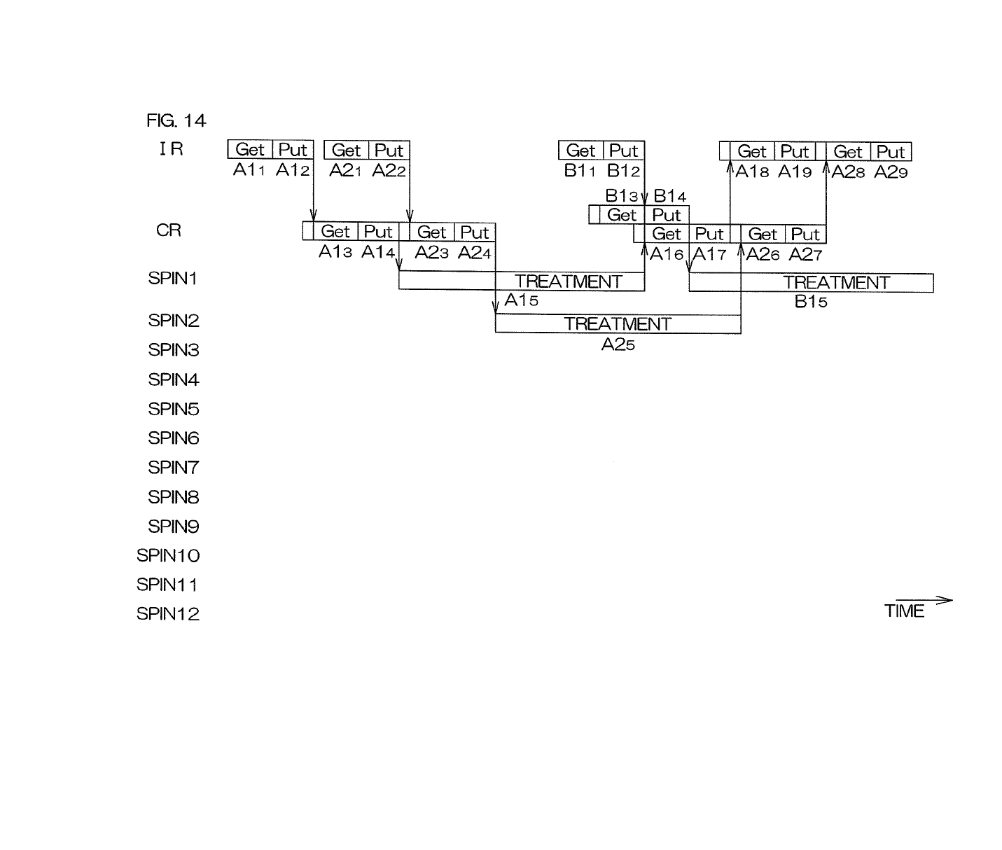

FIG. 14 shows an example of scheduling in which neither of preparation-execution condition nor postprocess-execution condition is satisfied. In this example, blocks A11-19 corresponding to the first substrate A1 for process job A are disposed. A treatment block A15 is disposed at a space in a treatment unit SPIN 1. As for a second substrate A2 for process job A, blocks A21-24 representing a substrate transfer procedure of an indexer robot IR corresponding to the substrate A2 and a main carrier robot CR and blocks A11-14 representing a substrate transfer procedure of an indexer robot IR corresponding to the first substrate A1 and the main carrier robot CR are designed so as not to interfere with each other. Further, a treatment block A25 corresponding to the second substrate A2 is disposed at a space in a treatment unit SPIN 2. Thus a schedule to parallel-process the two substrates A1 and A2 for process job A in the treatment unit SPIN 1 and SPIN 2 are prepared.

A recipe corresponding to the following process job B indicates, for example, parallel treatments in the treatment unit SPIN 1 and SPIN 2. So, blocks B11-19 corresponding to the substrate B1 are disposed in such a manner that a treatment block B15 for the first substrate B1 is disposed for the treatment unit SPIN 1 in which immediately preceding procedures finish earlier than the other. In FIG. 14, a block B14 which represents a transport of a substrate B1 by a main carrier robot CR into a treatment unit SPIN 1, and a block A16 which represents a transport of a substrate A1 by the main carrier robot CR out of the treatment unit SPIN 1 overlap with each other on time axis. This illustrates an temporally overlapping of a procedure in that the transfer of substrate B1 is executed with one side of hand 8A and a procedure in that the transfer of substrate A1 is executed with another side of hand 8B.

Descriptions hereinbelow refers again to FIG. 13. When a disposed treatment block satisfies a postprocess execution condition (STEP S27: “YES”), namely, when a treatment block immediately preceding the disposed treatment block requires a postprocess procedure for the same resource, the scheduling function member 25 disposes a postprocess block (STEP S28) just before the treatment block, or in other words after the immediately preceding treatment block. Thereafter a position to dispose a block is searched (STEP S29). The block is re-disposed at the position searched (STEP S30).

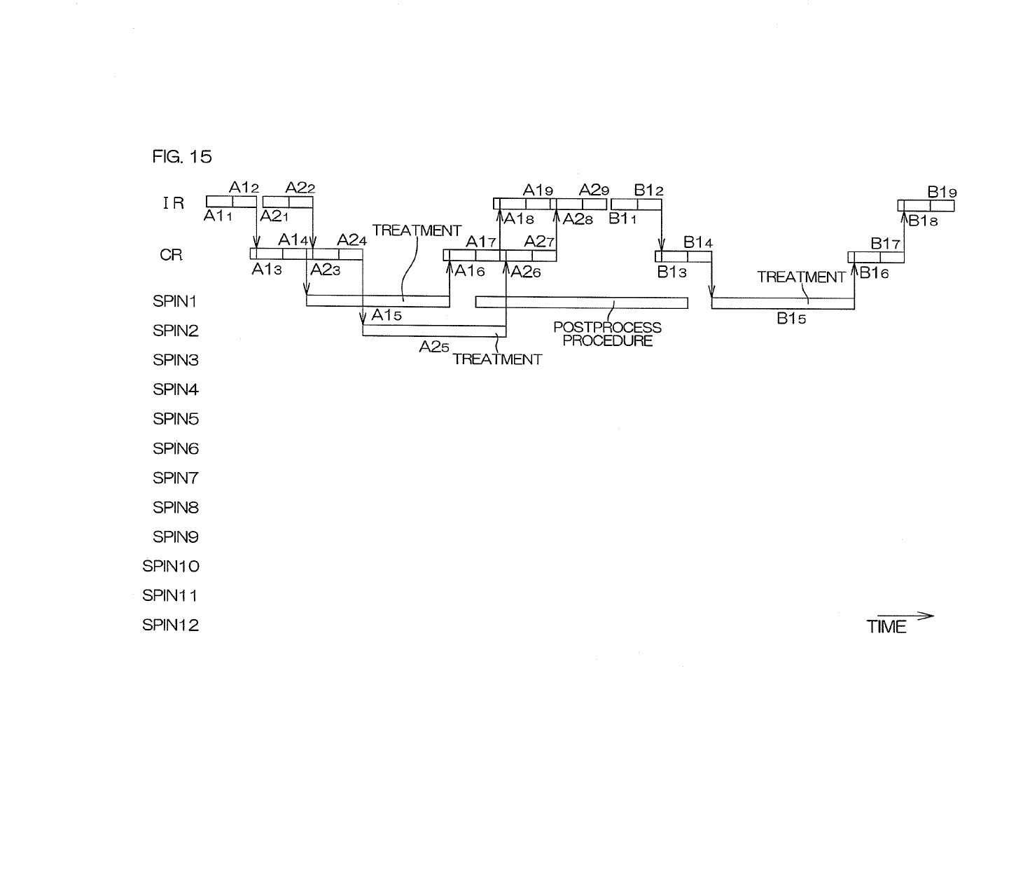

Specifically, for example, in FIG. 14, suppose that a blocks B11-15 corresponding to the first substrate for a process job B are disposed. Then suppose that disposition of a treatment block B15 satisfies a postprocess execution condition and it is determined that a postprocess procedure is required for a treatment block A15 immediately preceding the treatment block B15 for the same resource (treatment unit SPIN 1). In this case, a postprocess block is inserted between the treatment block A15 and B15. An example of such an insertion of postprocess block is shown in FIG. 15. Along with the insertion of the postprocess block, a treatment block B15 is disposed after the postprocess block, and B11-14 each preceding the treatment block B15, are shifted forward on time axis in sync with the disposition of the block B15. After the disposition of the treatment block B15, the rest of the blocks B16-19 are disposed in sync thereto.

When a disposed treatment block satisfies preparation execution condition (STEP S31 in FIG. 13 “YES”), the scheduling function member 25 disposes a preparation block immediately before the treatment block. Thereafter a position dispose block is searched (STEP S33). The block is re-disposed at the position searched (STEP S34).

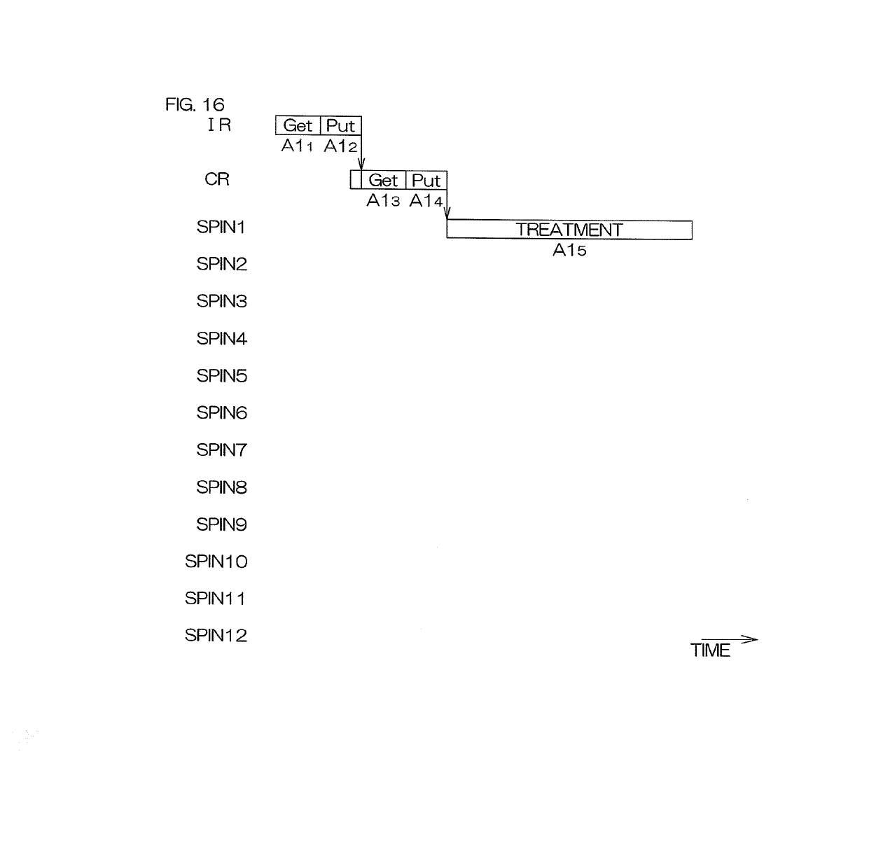

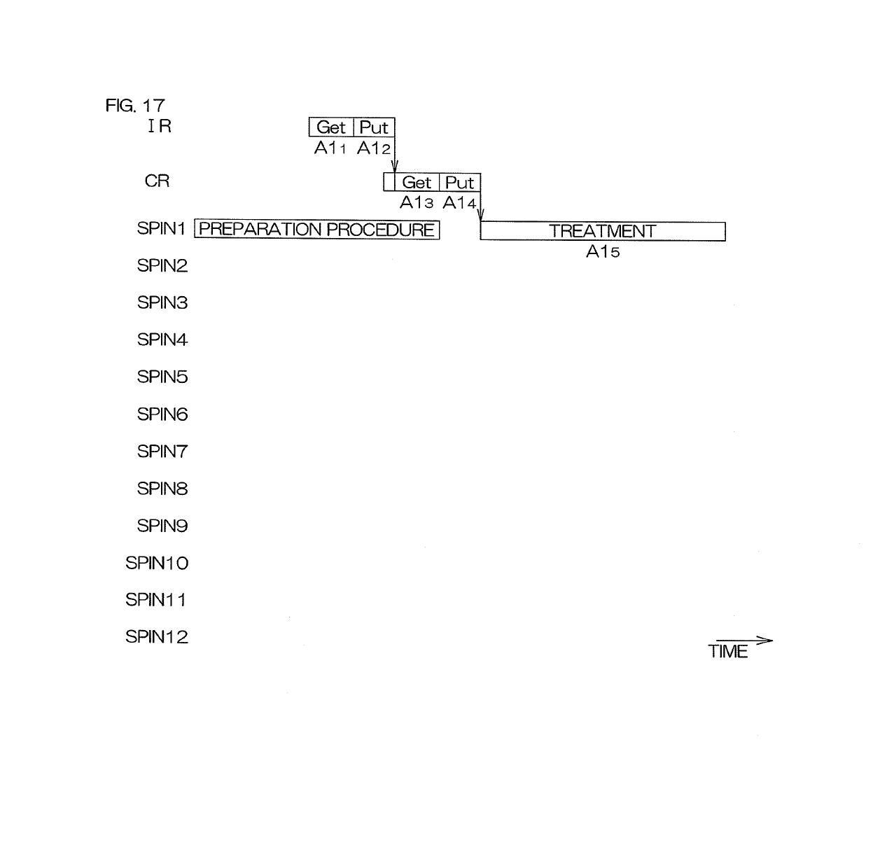

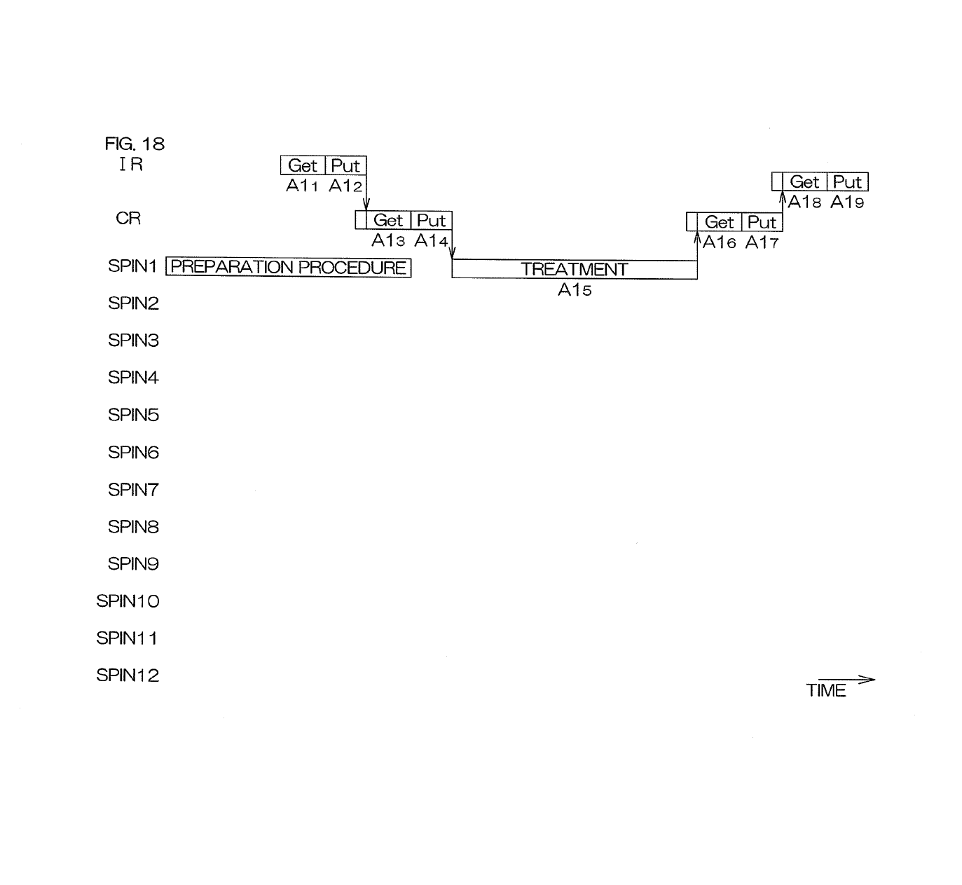

Specifically, for example, as shown in FIG. 16, suppose that blocks A11-15 corresponding to the first substrate A1 for process job A are disposed. Suppose that when a treatment block A15 is disposed thereafter, a preparation execution condition is satisfied and it is determined that preparation procedure for the treatment block A15 is required. In this case, a preparation block is inserted immediately preceding the treatment block A15. An example of an inserted preparation block is shown in FIG. 17. Along with the insertion of the preparation block, the treatment block A15 is disposed thereafter, and blocks A11-14 preceding the treatment block A15 are also shifted to the later side of time axis. After disposing the treatment block A15, rest of the blocks A16-19 are disposed, as shown in FIG. 18, in step with the disposition of the treatment block A15.

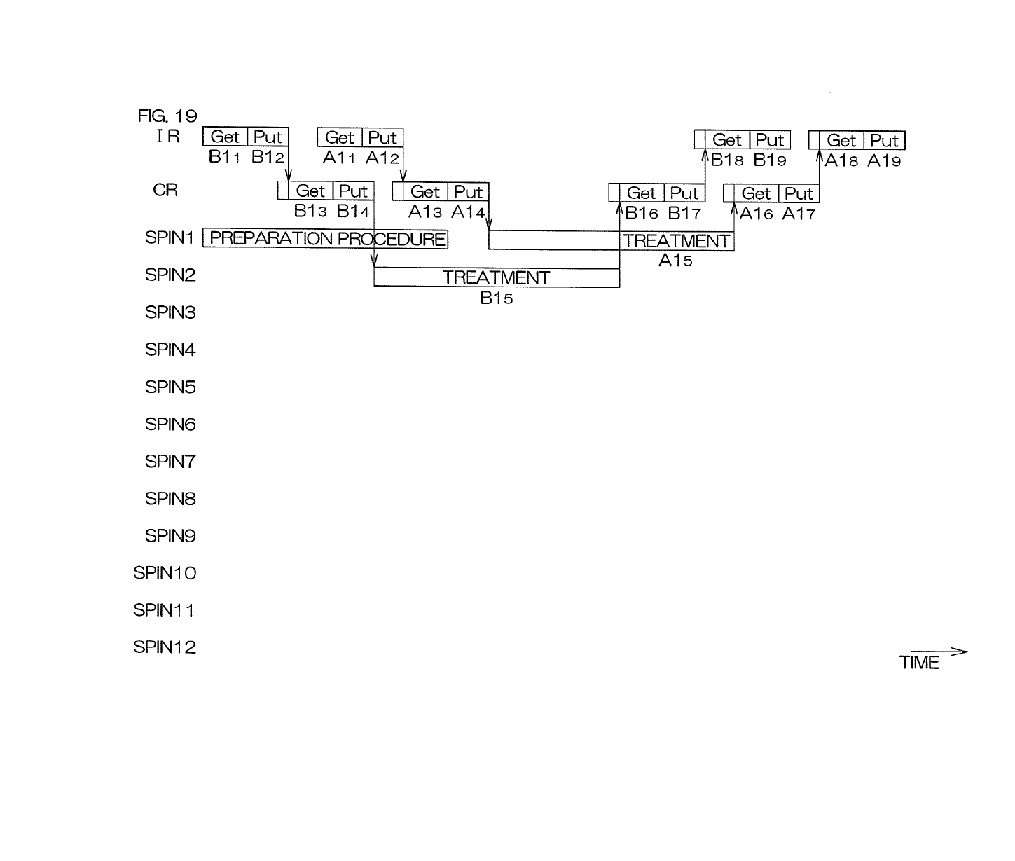

Preceding the start of scheduling for the process job A, a preparation block is disposed, of all the parallel treatment unit SPIN 1-12, only for the treatment unit SPIN 1 in which the treatment block A15 is disposed. Therefore as shown in FIG. 19, there may be a case in that when a treatment block B15 for a substrate B1 for another process job that is not required to have a preparation procedure is disposed at a space in a treatment unit SPIN 2, a group of treatment blocks for the substrate B1 can be disposed on the earlier side of time axis than the group of treatment blocks for the treatment of the substrate A1. In other words, treatment procedures for the substrate B1 that is transferred out of the substrate container C may be set ahead of treatment procedures for the substrate A1 that is transferred out of the substrate container C beforehand. Even in case without such overtaking, it is possible to start treatments for the substrate B1 earlier as a result of elimination of unnecessary preparations in the treatment unit SPIN 2. Therefore it is possible to increase availability ratios of resources by eliminating unnecessary preparations to increase productivity than that in the case of the first preferred embodiment.

Referring to FIG. 3, after completing disposition of all the blocks constituting tentative timetables corresponding to the all respective substrates with the process job code attached thereto (STEP S35: “YES”), the scheduling function member 25 determines whether a postprocess procedure is required for a treatment unit used for the process job (STEP S36). In other words, it is determined whether a postprocess execution condition is satisfied. The postprocess execution condition in such case preferably includes a condition in that the number of substrates treated in the treatment unit reaches a given number (for example, forty five pieces). If the postprocess execution condition is not satisfied (STEP S36: “NO”), the scheduling procedure for the process job is terminated (STEP S38). If the postprocess execution condition is satisfied (STEP S36: “YES”), a postprocess block is disposed at a space immediately after the last treatment block for treatment unit used for the process job (STEP S37), and the scheduling procedure for the process job is terminated (STEP S38).

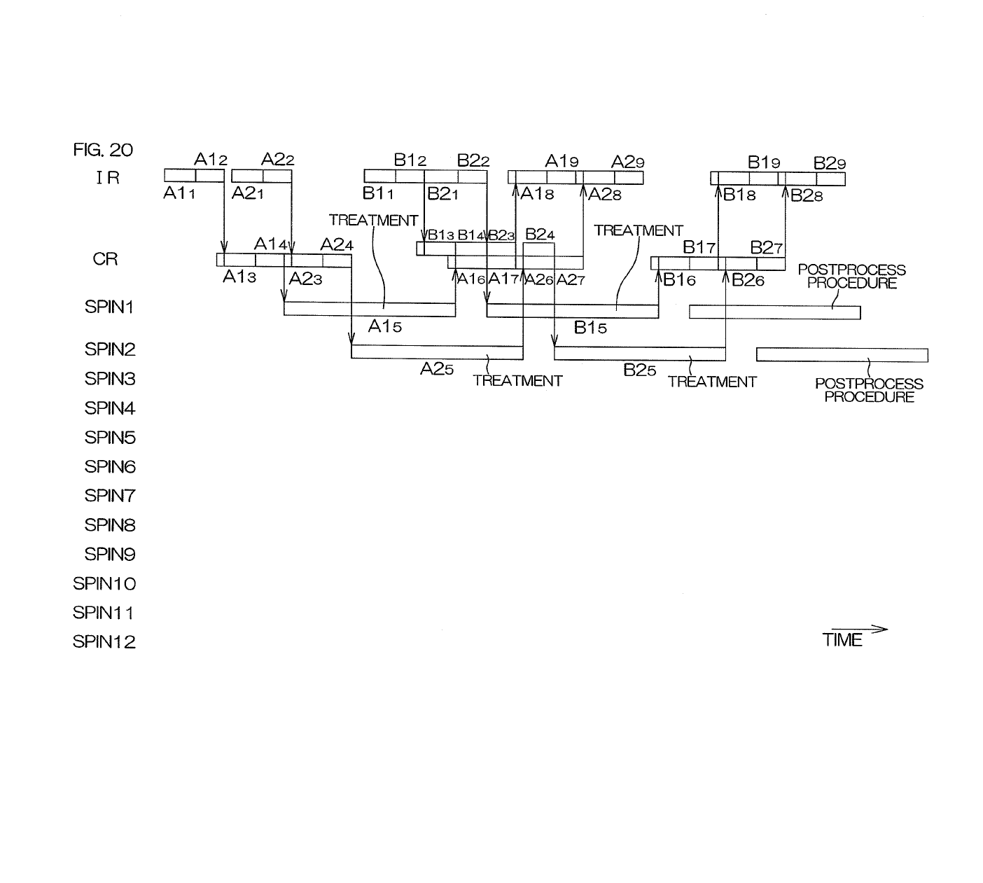

FIG. 20 illustrates a specific example in which postprocess treatment blocks are disposed. In FIG. 20, treatment units SPIN 1 and SPIN 2 are used for treatments for process job B. More specifically, a treatment block B15 and B25 respectively corresponding to the first substrate B1 and the second substrate B2, are disposed in the treatment units SPIN 1 and SPIN 2 respectively, each of them followed by a postprocess block so as to correspond to the SPIN 1 and SPIN 2 respectively.

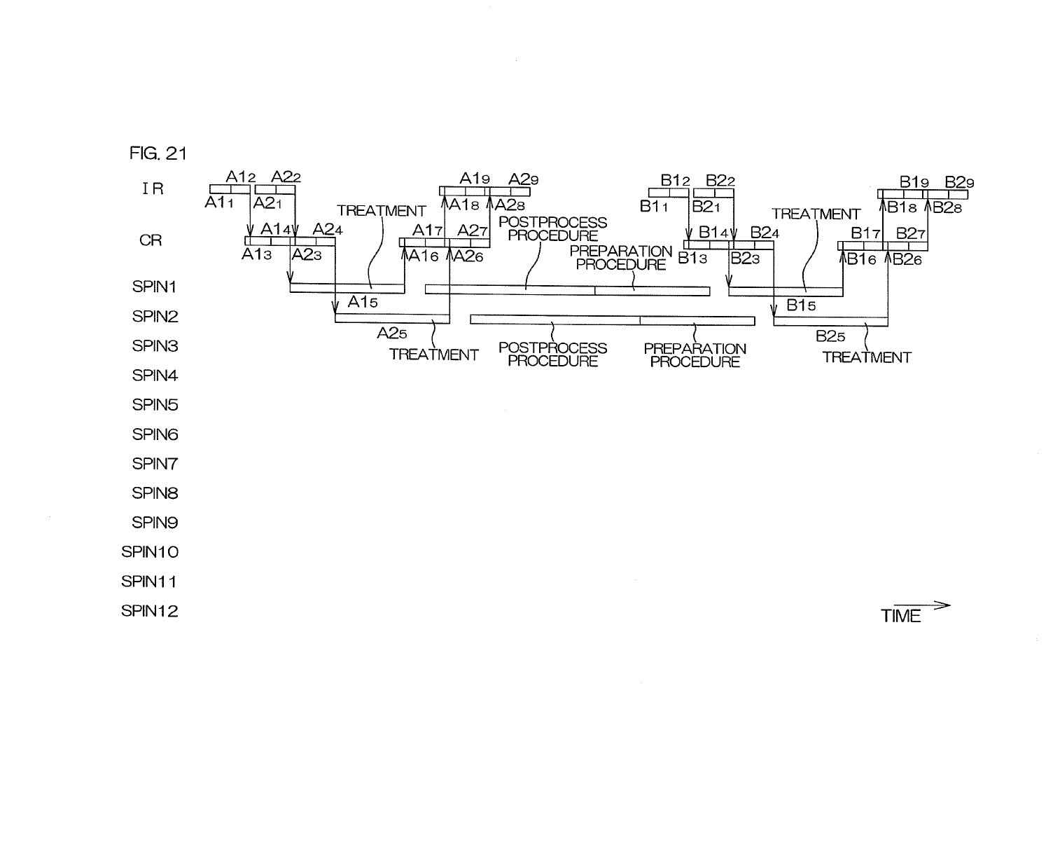

In FIG. 21 illustrates an example wherein as for a treatment block B15 for the first substrate B1 for the process job B, it is determined that a preceding treatment block A15 for the same resource requires a postprocess procedure and the treatment block B15 requires a preceding preparation procedure. Consequently, a postprocess and preparation blocks are sequentially disposed between the treatment block A15 and B15 disposed in spaces for the treatment unit SPIN 1. In this case, the postprocess block is disposed on the earlier side of the time axis and the preparation block is disposed on the later side of the time axis. In this example, it is determined likewise that, as for a treatment block B25 for the first substrate B2 for the process job B, a treatment block A25 preceding thereof for the same resource requires a postprocess procedure and the treatment block B25 requires a preceding preparation procedure. Corresponding thereto, a postprocess and preparation blocks are sequentially disposed between the treatment block A25 and B25 disposed in spaces for the treatment unit SPIN 2. In this case, the postprocess block is disposed on the earlier side of the time axis and the preparation block is disposed on the later side of the time axis.

As described hereinabove, tentative timetables for respective substrates, each of which combines a plurality of blocks each defining treatment content in a time sequential order, are prepared for every possible path. Thereafter blocks are acquired from the tentative timetables for a plurality of substrates W and are disposed in a time sequential order so as not to interfere with each other (not to use the same resource simultaneously) to prepare a total schedule and store it in a storage member 23. Thereby a total schedule capable of operating single-substrate type treatment units SPIN 1 to SPIN 12 can be prepared. A treatment execution indication member 26 activates each resources of the substrate treatment apparatus according to the total schedule stored in the storage member 23. Thereby it is possible to increase operating ratios for various parts of single-substrate type substrate treatment apparatus, improving productivity thereof.

Also, in this preferred embodiment, maintenance blocks for preparation procedure and/or postprocess procedure can be disposed. Thereby it is possible to execute maintenances required for before or after of the treatment of a substrate W for different process job, allowing high-quality substrate treatments.

Furthermore, in this preferred embodiment, when each of treatment blocks is disposed, it is determined whether maintenance blocks (a postprocess block and a preparation block) are required to be disposed. Therefore, compared to the first preferred embodiment in which preparation procedures are prepared in advance for all of the parallel treatment units indicated by recipes for respective process jobs, unnecessary preparation procedures are exempted. Accordingly, it is possible to dispose blocks consecutively with no gaps on time axis, thereby increasing operating rates of resources to improve productivity. Also, maintenance blocks are disposed only when required, exempting execution of unnecessary preparation or postprocess procedures. Thereby also, it is possible to increase operating ratios of resources (mainly treatment units), contributing to increase of productivity.

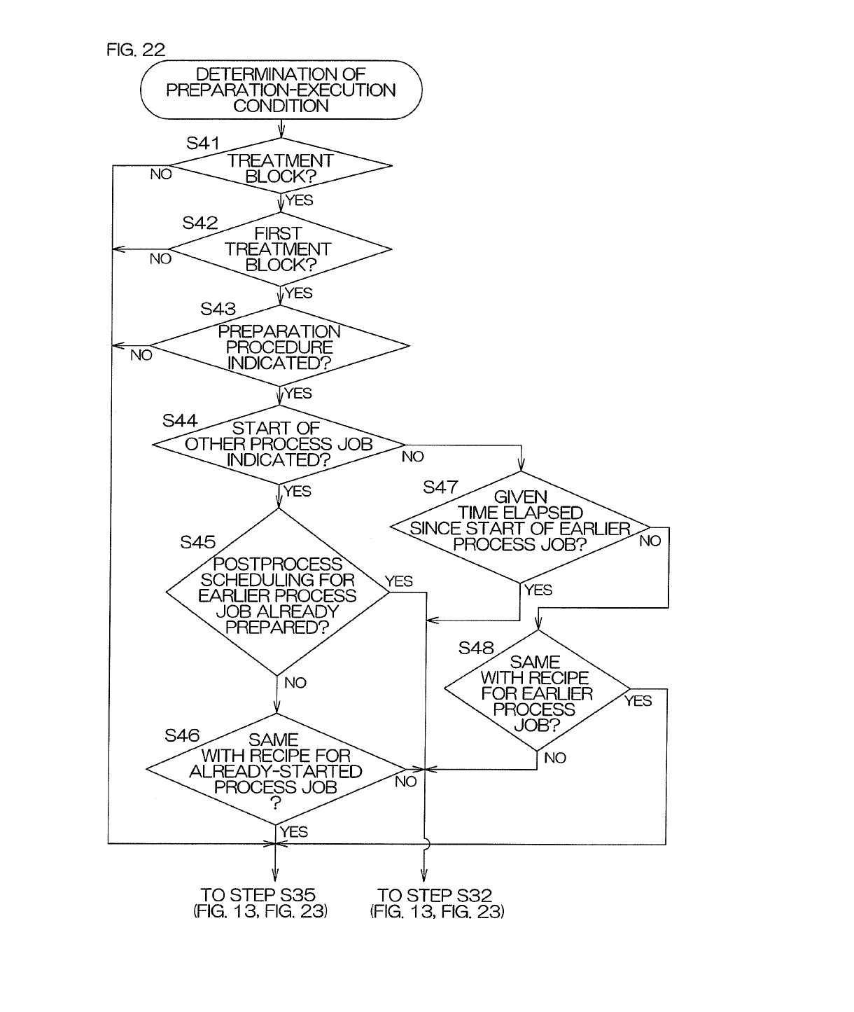

FIG. 22 is a flowchart showing a specific example of determination of preparation-execution condition (STEP S31 in FIG. 13). The scheduling function member 25 determines: whether a disposed block is a treatment block representing treatment in a treatment unit (STEP S41); whether the treatment block, of all the substrates for the under-scheduling process job, corresponds to the substrate which is to be treated first in the treatment unit (STEP S42); and whether a preparation procedure are indicated in a recipe for the under-scheduling process job (STEP S43). If any of the above is determined not to be true, the scheduling function member 25 does not dispose a preparation block.

If all outcomes of STEP S41-43 are determined to be affirmative, the scheduling function member 25 further determines whether there exists another process job indicated to start earlier (STEP S44). If this determination is affirmative, then the scheduling function member 25 determines whether a postprocess is prepared for the process job started earlier or not, or namely a postprocess block is disposed or not (STEP S45). If a postprocess block is disposed (STEP S45: “YES”), the scheduling function member 25 disposes a preparation block (STEP S32). If postprocess block is not disposed (STEP S45: “NO”), the scheduling function member 25 determines whether the earlier started process job and the process job under preparation are of the same recipe (STEP S46). If recipes are different (STEP S46: “NO”), the scheduling function member 25 disposes a preparation block (STEP S32). If recipes are the same (STEP S46: “YES”), the scheduling function member 25 skips disposition of a preparation block.

If there is no another process job indicated to start earlier (STEP S44: “NO”), the scheduling function member 25 determines whether more than a given time (for example, five minutes) has passed since the most recent process job started (STEP S47). If more than a given time has passed (STEP S47: “YES”), the scheduling function member 25 disposes a preparation block (STEP S32). If more than a given time has not passed (STEP S47: “NO”), the scheduling function member 25 further determines whether recipes for the most recent process job and in-preparation process job are the same or not (STEP S48). If recipes are the scheduling function member 25 skips disposition of a preparation block. If recipes are different (STEP S48: “NO”), the scheduling function member 25 disposes a preparation block.

In addition, determination herein may be made as to whether types of to-be-used chemical liquids are the same, instead of determining whether recipes are the (STEP S46, S48).

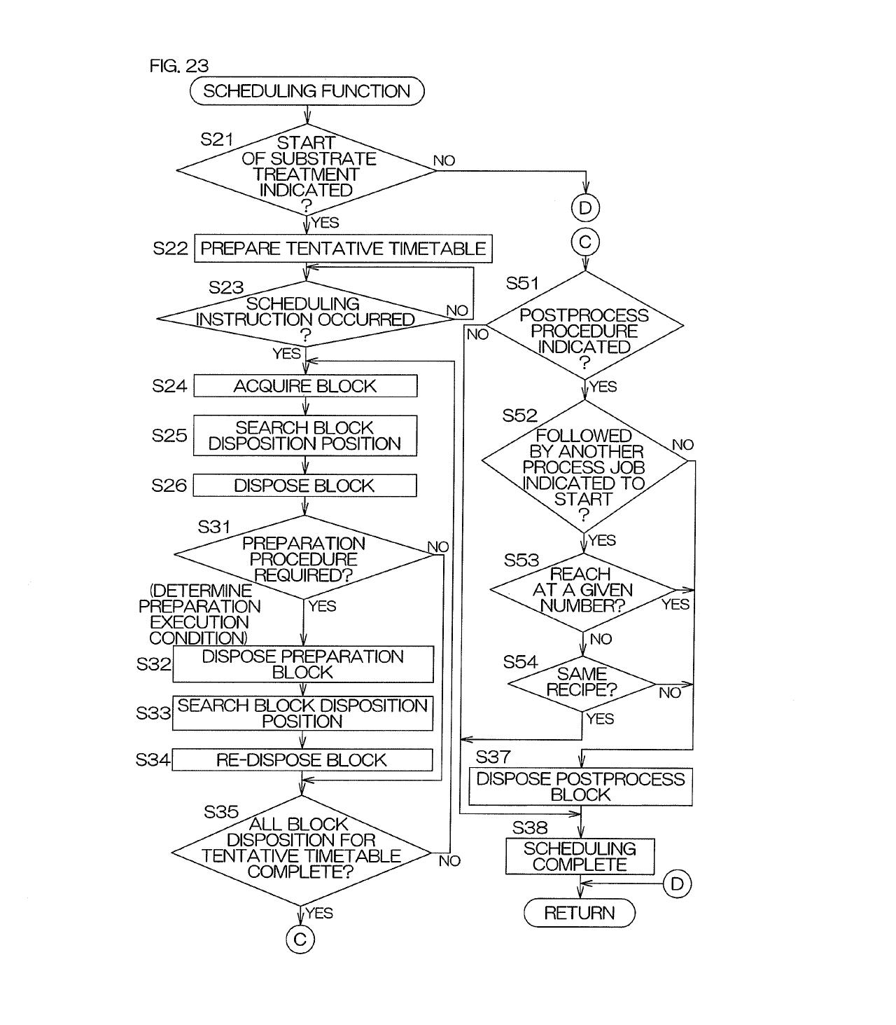

FIG. 23 is a flowchart for illustrating a third preferred embodiment of the present invention, in which an example of treatment executed by a scheduling-function member 25. In illustrating the third preferred embodiment, aforementioned FIG. 1-3 are to be referred again and differences with the second preferred embodiment will be mainly described. FIG. 23 illustrates treatments performed by a controller 21 (computer 20) through executing a scheduling program 31. In other words, in this preferred embodiment, the scheduling program 31 the scheduling program 31 is implanted with group of steps so as to execute treatments shown in FIG. 23. In FIG. 23, steps corresponding to respective similar steps shown in FIG. 13 are to be referred to by the same referential marks.

In the second preferred embodiment, in scheduling process jobs, a postprocess block is added for the most recent process job (STEP S27-30). On the other hand, in the third preferred embodiment, this procedure is skipped and it is determined whether a postprocess block is added to the under-scheduling process job based on a process job that is to be executed next.

Specifically, after completing disposition of all the blocks constituting tentative timetables corresponding to respective all substrates for a process job (STEP S35: “YES”), a postprocess execution condition determination treatment (STEPS S51-54) is executed. More specifically, the scheduling function member 25 determines whether a postprocess treatment is indicated in a recipe for a process job under-scheduling (STEP S51). If a postprocess is not indicated (STEP S51: “NO”), disposition of a postprocess block is skipped. If a postprocess is indicated (STEP S51: “YES”), the scheduling function member 25 determines whether another process job that is indicated to start after the under-scheduling process job (STEP S52). If there is not another process job satisfying the above condition (STEP S52: “NO”), the scheduling function member 25 disposes a postprocess block (STEP S37). If there is another process job satisfying the above condition (STEP S52: “YES”), the scheduling function member 25 determines whether a number of treated substrates after executing the most recent postprocess procedure reaches a given number (for example, forty five pieces) by executing the process job in a treatment unit used for the process job (STEP S53). If affirmatively determined, the scheduling function member 25 disposes a postprocess block at a space for a treatment block to be used for the process job (STEP S37). In case that the number of the treated substrates does not reach a given number (STEP S53: “NO”), the scheduling function member 25 determines recipe for the process job that is indicated to start after the under-scheduling process job and a recipe for the under-scheduling process job are the same (STEP S54). If the recipes are different (STEP S54: “NO”), the scheduling function member 25 disposes a postprocess block (STEP S37). If the recipes are the same (STEP S54: “YES”), the scheduling function member 25 skips disposition of a postprocess block.

In addition, determination herein may be made as to whether types of to-be-used chemical liquids are the same, instead of determining whether recipes are the same (STEP S54).

Thereby also in the third preferred embodiment, similar effects can be achieved as in the second preferred embodiment. To be more specifically, if recipes for consecutively executed process jobs are the same, a postprocess block for the process job that is executed earlier, and preparation block for the process job that is executed later. Thereby it is possible to increase rates of operation for treatment units, increasing productivity of substrate treatments. On the other hand, either in case that there exists a long time interval among process jobs or in case that a given number of substrates are treated, a postprocess block and a preparation block are disposed to maintain the interior of treatment chamber in good conditions. Thereby it is possible to ensure high-quality substrate treatment.

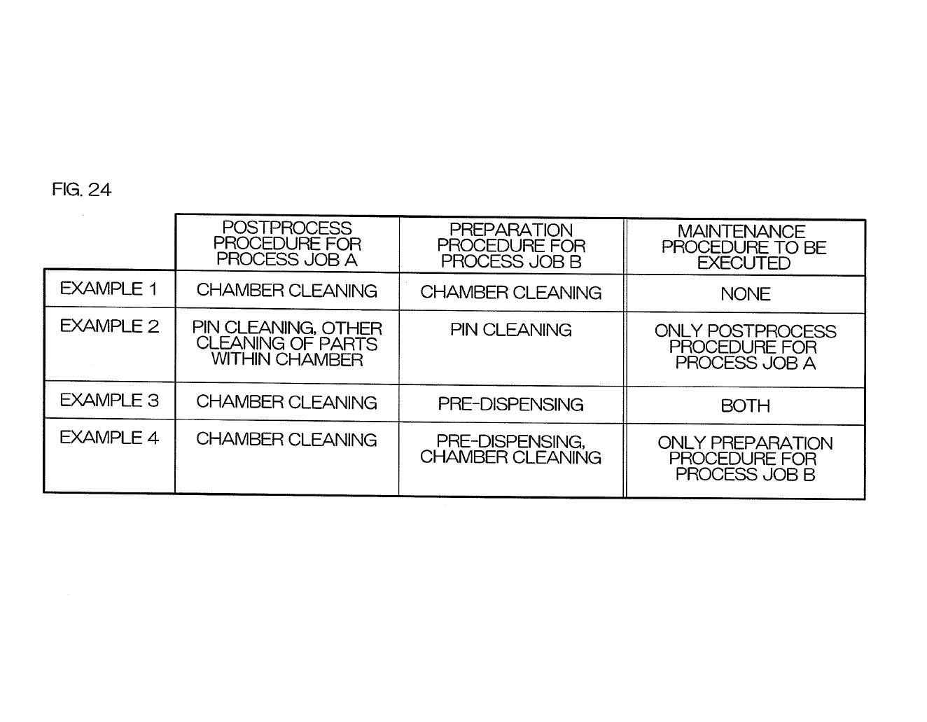

FIG. 24 illustrates another example of decision made at step S46 or S48 in FIG. 22, or step S54 in FIG. 23. Adding to or substituting the determination treatment shown in FIG. 22 and FIG. 23, it may be determined whether a postprocess block and preparation block can be disposed according to determination criteria exemplified in FIG. 24.

Specifically, examples of combinations postprocess procedure indicated by a recipe for process job A and a preparation procedure indicated by a recipe for process job B are shown in FIG. 24, wherein the process job A, B are process jobs which are to be executed in tandem.

As examples of preparation procedures, “CHAMBER CLEANING”, “PIN CLEANING”, and “PRE-DISPENSING” are listed. “CHAMBER CLEANING” is a cleaning treatment of interior of treatment chamber (chamber). “CHAMBER CLEANING” includes, example, cleaning of spin chuck, cleaning of treatment cup that accommodates a spin chuck, cleaning of guard (splash-proof member) for receiving treatment liquid splashed from spin chuck and the like. “PIN CLEANING” is a cleaning treatment of chuck pin provided in spin chuck for holding substrates. “PRE-DISPENSING” is a procedure for dispensing a certain amount of treatment liquid from treatment nozzle.

Also, as examples of postprocess procedures, “CHAMBER CLEANING”, “PIN CLEANING”, and “OTHER CLEANING OF PARTS WITHIN CHAMBER” are listed. Similar explanations may be applied for “CHAMBER CLEANING” and “PIN CLEANING”. “OTHER CLEANING OF PARTS WITHIN CHAMBER” is, for example, a treatment for cleaning other parts within treatment chamber, such as blocking plate arranged above spin chuck. A blocking plate may be provided within treatment chamber so as to prevent treatment liquid from splashing on substrate, by being moved closer to substrate when substrate is treated.

In the first example shown in FIG. 24, “CHAMBER CLEANING” is indicated as a postprocess procedure for process job A, and “CHAMBER CLEANING” is indicated as a preparation procedure for process job B. In this case, because the postprocess procedure for process job A and the preparation procedure for process job B is the same treatment, neither one of them is disposed. In the second example, two items “PIN CLEANING” and “OTHER CLEANING OF PARTS WITHIN CHAMBER” are indicated as postprocess treatments, and “PIN CLEANING” is indicated as a preparation procedure. In this case, there is an overlapping for “PIN CLEANING” between the postprocess procedure for process job A and the preparation procedure for process job B, postprocess procedure for process job A further including “OTHER CLEANING OF PARTS WITHIN CHAMBER”. Therefore, whereas postprocess blocks for process job A are disposed, preparation blocks for process job B are disposed. In the third example, “CHAMBER CLEANING” is indicated as a postprocess treatment for process job A, and “PRE-DISPENSING” is indicated as a preparation procedure for process job B. In this case, the postprocess procedure for process job A and the preparation procedure for process job B are different and have no partial overlapping. Therefore, both the postprocess block for process job A and the preparation block for process job B are disposed. In the fourth example, “CHAMBER CLEANING” is indicated as a postprocess procedure for process job A, and “PRE-DISPENSING” and “CHAMBER CLEANING” are indicated as preparation procedures for process job B. In this case, there is an overlapping for “CHAMBER CLEANING” between the postprocess procedure for process job A and the preparation procedure for process job B, the preparation procedure further including “PRE-DISPENSING”. Therefore, whereas disposition of the postprocess procedure for process job A is skipped, the preparation block for process job B is disposed.

As described hereinabove, in these examples, when a postprocess procedure for process job A that is to be executed earlier and a preparation procedure for process job B that is to be executed after the prior job A are precisely matched up together, both of them are skipped. Also, when a postprocess procedure for process job A and a preparation process procedure for process job B are partially overlapping and when either of the treatments (postprocess procedure or preparation procedure) includes whole of the treatment content of another, then only a block for the either one is disposed, skipping disposition of a block for the another. Thereby it is possible to avoid overlapping between a postprocess procedure and a preparation procedure, increasing rates of operation of treatment units and improving productivity of substrate treatment apparatus.

Although some of the preferred embodiments of the present invention gave been described in detail, it should be clear for those skilled in the art that the present invention may be put into practice in other modes as well. For example, the configuration of substrate treatment apparatus or the substrate treatment content illustrated in the aforementioned preferred embodiments are nothing but specific examples of the present invention; thus the substrate treatment apparatus may adapt other configuration and the substrate treatment content may adapt other content while applying the invention into practice.

Also, the program 30 may be provided in an form integrated into the computer 20, or may be provided in a form stored in a recording medium (computer readable recording medium such as CD-ROM, DVD-ROM or the like) other than the computer 20.

Although the preferred embodiments of the present invention have been described in detail, the embodiments are merely specific examples used to clarify the technical content of the present invention, and the present invention should not be understood as being limited to these specific examples; and the scope of the present invention is limited solely by the appended claims.

The present application corresponds to Japanese Patent Application No. 2011-203459 filed in the Japan Patent Office on Sep. 16, 2011 and Japanese Patent Application No. 2012-48393 filed in the Japan Patent Office on Mar. 5, 2012, the entire disclosure of which are incorporated herein by reference.

What is claimed is:

1. A scheduling method for a substrate treating apparatus having a single-substrate type treating unit for treating one single substrate at a time and a controller provided in the substrate treating apparatus for preparing schedule defining performances of the substrate treating apparatus in a time sequential order, comprising the steps of:
a step for preparing a plurality of tentative timetables for a plurality of respective substrates, each of the tentative timetables combining a plurality of blocks in a time sequential order, each of the blocks defining a treatment content for one of the substrates; and
a scheduling step for preparing a total schedule by acquiring the blocks from the plurality of tentative timetables to dispose the acquired blocks in a time sequential order.

2. The scheduling method according to claim 1, wherein the scheduling step includes a maintenance block disposing step for disposing a maintenance block for a maintenance procedure that is to be executed either before or after a treatment of a substrate.

3. The scheduling method according to claim 2, wherein each of the tentative timetables includes a treatment block representing a treatment to be executed for a substrate in the treating unit, and the maintenance block disposing step includes: a step for determining whether the treatment block satisfies a given maintenance-execution condition or not; and a step for disposing the maintenance block before the treatment block in a time axis when the treatment block satisfies the maintenance-execution condition.

4. The scheduling method according to claim 2, wherein each of the tentative timetables includes a treatment block representing a treatment to be executed for a substrate in the treating unit, and the maintenance block disposing step includes:
a step for determining whether a first treatment that is scheduled for a first substrate and is to be executed by the treatment unit, and a second treatment that is scheduled for a second substrate and is to be executed next by the treatment unit satisfy a given maintenance-execution condition; and
a step for disposing the maintenance block between a first treatment block for the first treatment and a second treatment block for the second treatment.

5. The scheduling method according to claim 4, wherein the maintenance-execution condition includes any of a condition for elapsed time from a end of the first treatment block to a start of the second treatment block, a condition for treatment content for the first and second treatment, and a condition for a number of treated substrates in the treatment unit.

6. The scheduling method according to claim 2, wherein each the tentative timetables includes a treatment block representing a treatment to be executed for a substrate in the treatment unit, and the maintenance block disposing step includes
a step for determining whether a first treatment by the treatment unit which is scheduled for a first substrate, and a second treatment by the treatment unit which is scheduled for a second substrate that is to be executed by the treatment unit after the first substrate are same or not; and
a step for disposing the maintenance block between a first treatment block for the first treatment and a second treatment block for the second treatment when the first treatment and the second treatment are different, and skipping disposition of the maintenance block when the first treatment and the second treatment are same.

7. The scheduling method according to claim 2, wherein each of the tentative timetables includes a treatment block representing a treatment to be executed for a substrate in the treating unit, and the maintenance block disposing step includes:
a step for determining whether a postprocess procedure that is to be executed by the treatment unit after a treatment of a first substrate, and a preparation process that is to be executed in the treatment unit before a treatment of a second substrate, wherein the second substrate is to be treated by the treatment unit after the first substrate, are same or not; and
a step for disposing a postprocess block for the postprocess procedure and a preparation block for the preparation procedure between a first treatment block for the first substrate and a second treatment block for the second substrate as the maintenance block when the postprocess procedure and the preparation process procedure are different, and skipping disposition of the maintenance block when the postprocess procedure and the preparation procedure are same.

8. The scheduling method according to claim 6, wherein the maintenance block disposing step includes:
a step for determining whether a part of a treatment content of either one of the postprocess procedure and preparation procedure, and an entirety of a treatment content of another one of the postprocess procedure and preparation procedure are same or not; and
a step for disposing a maintenance block corresponding to the either one of the postprocess procedure and preparation procedure between a first treatment block for the first substrate and a second treatment block for the second substrate, and skipping disposition of a maintenance block corresponding to the procedure, when a part of a treatment content of the either one and an entirety of a treatment content of the another one are same.

9. A recording medium having a computer program recorded thereon for a substrate treating apparatus having a single-substrate type treating unit for treating one single substrate at a time, preparing a schedule defining performances of the substrate treating apparatus in a time sequential order, in which the computer program a set of instruction steps is encoded so that any one of the method according to claims 1 to 8 is executable on a computer as the controller.
